(19) United States
(12) Patent Application Publication
(10) Pub. No.: US 2025/0310547 A1
(43) Pub. Date: Oct. 2, 2025

(54) PICTURE FILTERING

(71) Applicant: TENCENT TECHNOLOGY (SHENZHEN) COMPANY LIMITED, Shenzhen (CN)

(72) Inventors: Renjie CHANG, Shenzhen (CN); Liqiang WANG, Shenzhen (CN)

(73) Assignee: TENCENT TECHNOLOGY (SHENZHEN) COMPANY LIMITED, Shenzhen (CN)

(21) Appl. No.: 19/239,741

(22) Filed: Jun. 16, 2025

Related U.S. Application Data
(63) Continuation of application No. PCT/CN2024/080175, filed on Mar. 5, 2024.

(30) Foreign Application Priority Data
Apr. 14, 2023 (CN) 202310430930.X

(51) Int. Cl. H04N 19/186; H04N 19/117; H04N 19/176; H04N 19/82; H04N 19/96

(52) U.S. Cl. CPC H04N 19/186; H04N 19/117; H04N 19/176; H04N 19/82; H04N 19/96

(57) ABSTRACT

A picture filtering method of a decoder is provided. In the method, a current picture encoded in a coded bitstream is reconstructed. A target filtering order, for a current block in the reconstructed current picture, is determined from a plurality of filtering orders of a first chrominance component and a second chrominance component of the current block. Based on the determined target filtering order, the first chrominance component and the second chrominance component of the current block are input into a neural network filter to obtain a chrominance filtering block of the current block. Apparatus and non-transitory computer-readable storage medium counterpart embodiments are also contemplated.

### RELATED APPLICATIONS

The present application is a continuation of International Application No. PCT/CN2024/080175, filed on Mar. 5, 2024, which claims priority to Chinese Patent Application No. 202310430930.X, filed on Apr. 14, 2023, and entitled “PICTURE FILTERING METHOD AND APPARATUS, DEVICE, AND STORAGE MEDIUM”, which are incorporated herein by reference in their entirety.

### FIELD OF THE TECHNOLOGY

Embodiments of this disclosure relate to the technical field of picture coding and decoding, including to a picture filtering method and apparatus, a device, and a storage medium.

### BACKGROUND OF THE DISCLOSURE

With the development of video technologies, a large amount of data is included in video data. To facilitate transmission of the video data, a video apparatus performs a video compression technology to more efficiently transmit or store the video data. During the video compression, an encoder side and a decoder side each perform operations such as inverse quantization and inverse transform to obtain a reconstructed picture. Since a loss is introduced to the video compression, the reconstructed picture is filtered to reduce a compression loss of the picture.

With the rapid development of neural network technologies, neural network filters are widely applied to video processing. However, the current neural network filter faces issues of poor generalization and a poor filtering effect when filtering chrominance components.

### SUMMARY

This disclosure provides a picture filtering method and apparatus, a device, and a storage medium to improve the filtering effect of a picture and the generalization of a neural network filter.

According to an aspect, a picture filtering method of a decoder is provided. In the method, a current picture encoded in a coded bitstream is reconstructed. A target filtering order, for a current block in the reconstructed current picture, is determined from a plurality of filtering orders of a first chrominance component and a second chrominance component of the current block. Based on the determined target filtering order, the first chrominance component and the second chrominance component of the current block are input into a neural network filter to obtain a chrominance filtering block of the current block.

According to an aspect, a picture filtering method of an encoder is provided. In the method, a current picture is encoded. The encoded current picture is reconstructed. A target filtering order, for a current block in the reconstructed current picture, is determined from a plurality of filtering orders of a first chrominance component and a second chrominance component of the current block. Based on the determined target filtering order, the first chrominance component and the second chrominance component of the current block are input into a neural network filter to obtain a chrominance filtering block of the current block.

According to an aspect, a decoding apparatus including processing circuitry is provided. The processing circuitry is configured to reconstruct a current picture that is encoded in a coded bitstream. The processing circuitry is configured to determine, for a current block in the reconstructed current picture, a target filtering order from a plurality of filtering orders of a first chrominance component and a second chrominance component of the current block. The processing circuitry is configured to input, based on the determined target filtering order, the first chrominance component and the second chrominance component of the current block into a neural network filter to obtain a chrominance filtering block of the current block.

According to an aspect, an encoding apparatus including processing circuitry is provided. The processing circuitry is configured to encode a current picture and reconstruct the encoded current picture. The processing circuitry is configured to determine, for a current block in the reconstructed current picture, a target filtering order from a plurality of filtering orders of a first chrominance component and a second chrominance component of the current block. The processing circuitry is configured to input, based on the determined target filtering order, the first chrominance component and the second chrominance component of the current block into a neural network filter to obtain a chrominance filtering block of the current block.

According to an aspect, this disclosure provides a picture filtering method, applied to a decoding device, including the following operations:
decoding a code stream of a current picture to obtain a residual value of the current picture, and determining a reconstructed picture of the current picture based on the residual value;
determining, for a to-be-filtered current picture block in the reconstructed picture, a target filtering order of a first chrominance component and a second chrominance component of the current picture block, the target filtering order being determined by decoding the code stream or based on filtering costs of N filtering orders, and N being a positive integer greater than 1; and
inputting, based on the target filtering order, the first chrominance component and the second chrominance component of the current picture block into a neural network filter for filtering to obtain a chrominance filtering block of the current picture block.

According to an aspect, this disclosure provides a picture filtering method, applied to a coding device, including the following operations:
coding a current picture to obtain a reconstructed picture of the current picture;
determining, for a to-be-filtered current picture block in the reconstructed picture, a target filtering order of a first chrominance component and a second chrominance component of the current picture block, the target filtering order being determined based on filtering costs of N filtering orders, and N being a positive integer greater than 1; and
inputting, based on the target filtering order, the first chrominance component and the second chrominance component of the current picture block into a neural network filter for filtering to obtain a filtered picture block of the current picture block.

According to an aspect, this disclosure provides a picture filtering apparatus, applied to a decoding device, including:
a decoding unit configured to decode a code stream of a current picture to obtain a residual value of the current picture, and determine a reconstructed picture of the current picture based on the residual value;
an order determining unit configured to determine, for a to-be-filtered current picture block in the reconstructed picture, a target filtering order of a first chrominance component and a second chrominance component of the current picture block, the target filtering order being determined by decoding the code stream or based on filtering costs of N filtering orders, and N being a positive integer greater than 1; and
a filtering unit configured to input, based on the target filtering order, the first chrominance component and the second chrominance component of the current picture block into a neural network filter for filtering to obtain a chrominance filtering block of the current picture block.

According to an aspect, this disclosure provides a picture filtering apparatus, applied to a coding device, including:
a coding unit (CU) configured to code a current picture to obtain a reconstructed picture of the current picture;
an order determining unit configured to determine, for a to-be-filtered current picture block in the reconstructed picture, a target filtering order of a first chrominance component and a second chrominance component of the current picture block, the target filtering order being determined based on filtering costs of N filtering orders, and N being a positive integer greater than 1; and
a filtering unit configured to input, based on the target filtering order, the first chrominance component and the second chrominance component of the current picture block into a neural network filter for filtering to obtain a filtered picture block of the current picture block.

According to an aspect, a decoder is provided, including a processor and a memory. The memory is configured to store a computer program, and the processor is configured to invoke and run a computer program stored in the memory to perform the method according to the foregoing aspect or implementations thereof.

According to an aspect, an encoder is provided, including a processor and a memory. The memory is configured to store a computer program, and the processor is configured to invoke and run a computer program stored in the memory to perform the method according to the foregoing aspect or implementations thereof.

According to an aspect, a chip is provided, configured to implement the method according to any one of the aspects or implementations thereof. Specifically, the apparatus includes: a processor configured to invoke and run a computer program from a memory to cause a device on which the chip is installed to perform the method according to any one of the first aspect to the second aspect or implementations thereof.

According to an aspect, a non-transitory computer-readable storage medium is provided, configured to store a computer program for causing a computer to perform the method according to any one of the aspects or implementations thereof.

According to an aspect, a computer program product is provided, including computer program instructions for causing a computer to perform the method according to any aspects or implementations thereof.

According to a tenth aspect, a computer program is provided, and the computer program, when run on a computer, causes the computer to perform the method according to any one of the first aspect to the second aspect or implementations thereof.

In summary, in this disclosure, the reconstructed picture of the current picture is determined. For the to-be-filtered current picture block in the reconstructed picture, the target filtering order of the first chrominance component and the second chrominance component of the current picture block is determined. The target filtering order is determined by decoding the coded stream or based on the filtering costs of the N filtering orders, and N is a positive integer greater than 1. Based on the target filtering order, the first chrominance component and the second chrominance component of the current picture block are inputted into the neural network filter for filtering to obtain the chrominance filtering block of the current picture block. That is, in the embodiments of this disclosure, the target filtering order is determined based on the filtering costs of the N filtering orders so that the accuracy of selecting the target filtering order is improved. When the first chrominance component and the second chrominance component of the current picture block are inputted into the neural network filter for filtering based on the determined target filtering order, the filtering effect may be improved, thereby improving the generalization of the neural network filter and improving the picture coding and decoding performance.

### BRIEF DESCRIPTION OF THE DRAWINGS

FIG. 1 is a schematic block diagram of a video coding and decoding system according to an embodiment of this disclosure.

FIG. 2 is a schematic diagram of a coding framework according to an embodiment of this disclosure.

FIG. 3 is a schematic diagram of a decoding framework according to an embodiment of this disclosure.

FIG. 4 is a schematic diagram of a CU according to an embodiment of this disclosure.

FIG. 5 is a schematic diagram of a filtering process of a neural network filter according to an embodiment of this disclosure.

FIG. 6A is a schematic diagram of a chrominance training order of a neural network filter according to an embodiment of this disclosure.

FIG. 6B is a schematic diagram of a filtering order of a neural network filter according to an embodiment of this disclosure.

FIG. 7 is a schematic flowchart of a picture filtering method according to an embodiment of this disclosure.

FIG. 8A to FIG. 8C are schematic diagrams of a current picture block according to an embodiment of this disclosure.

FIG. 9 is a schematic diagram of a surrounding filtered area of a current picture block according to an embodiment of this disclosure.

FIG. 10 is a schematic diagram of determining a target filtering order according to an embodiment of this disclosure.

FIG. 11A to FIG. 12B are schematic diagrams of determining a target filtering order according to an embodiment of this disclosure.

FIG. 13 is a schematic flowchart of a picture filtering method according to an embodiment of this disclosure.

FIG. 14 is a schematic diagram of determining a target filtering order according to an embodiment of this disclosure.

FIG. 15A and FIG. 15B are schematic diagrams of determining a target filtering order according to an embodiment of this disclosure.

FIG. 16 is a schematic block diagram of a picture filtering apparatus according to an embodiment of this disclosure.

FIG. 17 is a schematic block diagram of a picture filtering apparatus according to an embodiment of this disclosure.

FIG. 18 is a schematic block diagram of an electronic device according to an embodiment of this disclosure.

### DESCRIPTION OF EMBODIMENTS

The technical solutions in embodiments of this disclosure are described in the following with reference to the accompanying drawings. The described embodiments are merely some rather than all of the embodiments of this disclosure. Based on the embodiments of the present disclosure, other embodiments are within the scope of this disclosure.

The terms “first”, “second”, and the like in the specification and claims of this disclosure and the foregoing drawings are used for distinguishing similar objects and are not necessarily used for describing a particular order or sequence. The data so used may be interchangeable where appropriate so that the embodiments of this disclosure described herein, for example, can be implemented in an order other than those illustrated or described herein. In the embodiments of the present disclosure, “B corresponding to A” represents that B is associated with A. In an implementation, B may be determined according to A. However, determining B according to A does not mean determining B according to A alone, but also according to A and/or other information. Moreover, the terms “include”, “have”, and any other variants mean to cover the non-exclusive inclusion, for example, a process, method, system, product, or server that includes a list of steps or units is not necessarily limited to those expressly listed steps or units, but may include other steps or units not expressly listed or inherent to such a process, method, product, or device. In the description of this disclosure, unless otherwise stated, “a plurality of” means two or more than two.

This disclosure may be applied to the field of picture coding and decoding, the field of video coding and decoding, the field of hardware video coding and decoding, the field of dedicated circuit video coding and decoding, the field of real-time video coding and decoding, and the like. For example, the solutions of this disclosure may be incorporated into a deep learning-based end-to-end picture coding standard, such as JPEG AI. Alternatively, the solutions of this disclosure may be operated by combining with other proprietary or industry standards, which contain ITU-TH.261, ISO/IECMPEG-1 Visual, ITU-TH.262 or ISO/IECMPEG-2Visual, ITU-TH.263, ISO/IECMPEG-4Visual, ITU-TH.264 (also referred to as ISO/IECMPEG-4AVC), and scalable video coding (SVC) and multiview video coding (MVC) extensions. The technology of this disclosure is not limited to any particular coding and decoding standard or technology.

For ease of understanding, a video coding and decoding system according to an embodiment of this disclosure will first be described with reference to FIG. 1.

FIG. 1 is a schematic block diagram of a video coding and decoding system according to an embodiment of this disclosure. FIG. 1 is merely an example, and the video coding and decoding system according to this embodiment of this disclosure includes but is not limited to that shown in FIG. 1. As shown in FIG. 1, a video coding and decoding system 100 contains a coding device 110 and a decoding device 120. The coding device is configured to code (which may be understood as compressing or encoding) video data to generate a code stream, and transmit the code stream to the decoding device. The decoding device decodes the code stream generated by coding through the coding device to obtain decoded video data.

In this embodiment of this disclosure, the coding device 110 may be understood as a device having a video coding function, and the decoding device 120 may be understood as a device having a video decoding function. That is, in this embodiment of this disclosure, the coding device 110 and the decoding device 120 include a wider range of apparatuses, such as a smartphone, a desktop computer, a mobile computing apparatus, a notebook computer (for example, a laptop), a tablet computer, a set-top box, a television, a camera, a display apparatus, a digital media player, a video game console, and an in-vehicle computer.

In some embodiments, the coding device 110 may transmit coded video data (for example, a code stream) to the decoding device 120 through a channel 130. The channel 130 may include one or more media and/or apparatuses capable of transmitting the coded video data from the coding device 110 to the decoding device 120.

In one example, the channel 130 includes one or more communication media enabling the coding device 110 to directly transmit the coded video data to the decoding device 120 in real time. In this example, the coding device 110 may modulate the coded video data according to a communication standard and transmit modulated video data to the decoding device 120. The communication medium contains a wireless communication medium, such as a radio frequency spectrum. In some embodiments, the communication medium may further contain a wired communication medium, such as one or more physical transmission lines.

In another example, the channel 130 includes a storage medium, and the storage medium may store video data coded by the coding device 110. The storage medium contains multiple local access data storage media, such as an optical disc, a digital video disc (DVD), and a flash memory. In this example, the decoding device 120 may acquire the coded video data from the storage medium.

In another example, the channel 130 may contain a storage server, and the storage server may store the video data coded by the coding device 110. In this example, the decoding device 120 may download the stored coded video data from the storage server. In some embodiments, the storage server may store the coded video data and transmit the coded video data to the decoding device 120, such as a web server (e.g., for a website) and a file transfer protocol (FTP) server.

In some embodiments, the coding device 110 contains a video coder 112 and an output interface 113. The output interface 113 may contain a modulator/demodulator (modem) and/or a transmitter.

In some embodiments, besides the video coder 112 and the output interface 113, the coding device 110 may further include a video source 111.

The video source 111 may contain at least one of a video capture apparatus (for example, a video camera), a video archive, a video input interface, and a computer graphics system. The video input interface is configured to receive video data from a video content provider, and the computer graphics system is configured to generate video data.

The video coder 112 codes video data from the video source 111 to generate a code stream. The video data may include one or more pictures or a sequence of pictures. The code stream includes coded information of the picture or the sequence of pictures in a form of a bitstream. The coded information may contain coded picture data and associated data. The associated data may contain a sequence parameter set (SPS), a picture parameter set (PPS), and other syntax structures. The SPS may contain parameters applied to one or more sequences. The PPS may contain parameters applied to one or more pictures. The syntax structure refers to a set of zero or a plurality of syntax elements arranged in a specified order in the code stream.

The video coder 112 directly transmits the coded video data to the decoding device 120 via the output interface 113. The coded video data may further be stored on a storage medium or a storage server for subsequent reading by the decoding device 120.

In some embodiments, the decoding device 120 contains an input interface 121 and a video decoder 122.

In some embodiments, besides the input interface 121 and the video decoder 122, the decoding device 120 may further include a display apparatus 123.

The input interface 121 contains a receiver and/or a modem. The input interface 121 may receive the coded video data through the channel 130.

The video decoder 122 is configured to decode the coded video data to obtain decoded video data, and transmit the decoded video data to the display apparatus 123.

The display apparatus 123 displays the decoded video data. The display apparatus 123 may be integrated with the decoding device 120 or external to the decoding device 120. The display apparatus 123 may include multiple display apparatuses, such as a liquid crystal display (LCD), a plasma display, an organic light emitting diode (OLED) display, or another type of display apparatus.

In addition, FIG. 1 is merely an example, and the technical solutions of the embodiments of this disclosure is not limited to FIG. 1. For example, the technology of this disclosure may further be applied to single-side video coding or single-side video decoding.

A video coding framework involved in the embodiments of this disclosure are described below.

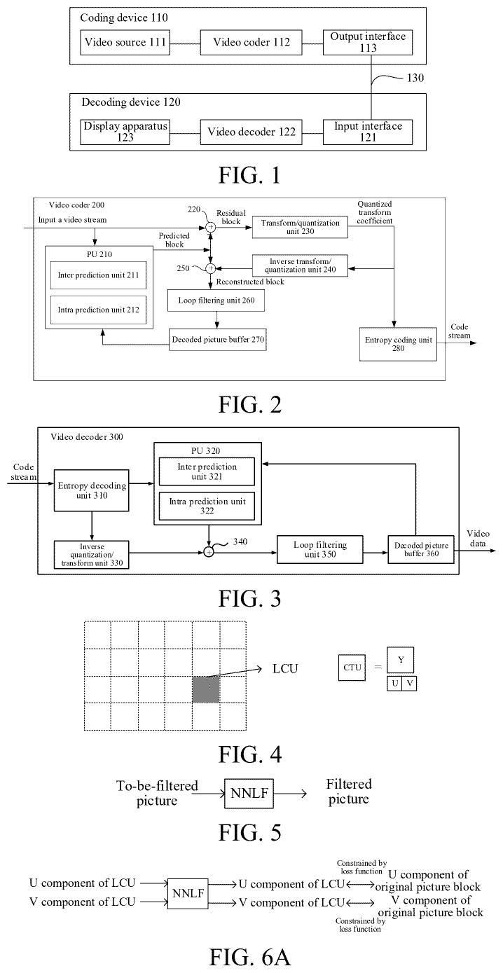

FIG. 2 is a schematic block diagram of a video coder according to an embodiment of this disclosure. The video coder 200 may be configured to perform lossy compression on a picture, or may be configured to perform lossless compression on a picture. The lossless compression may be visually lossless compression, or may be mathematically lossless compression.

The video coder 200 may be applied to picture data in a luminance and chrominance (YCbCr, YUV) format. For example, a YUV ratio may be 4:2:0, 4:2:2, or 4:4:4, where Y represents the luminance (Luma), Cb (U) represents blue chrominance, Cr (V) represents red chrominance, and U and V represent chroma for describing colors and saturation. For example, in a color format, 4:2:0 represents that every four pixels have four luminance components and two chrominance components (YYYYCbCr), 4:2:2 represents that every four pixels have four luminance components and four chrominance components (YYYYCbCrCbCr), and 4:4:4 represents full pixel display (YYYYCbCrCbCrCbCrCbCr).

For example, the video coder 200 reads video data, and for each frame of picture in the video data, divides the frame of picture into several coding tree units (CTUs). In some examples, the CTU may be referred to as a “tree block”, a “largest coding unit (LCU)”, or a “coding tree block (CTB)”. Each CTU may be associated with pixel blocks having equal sizes in the picture. Each pixel may correspond to one luminance (or luma) sample and two chrominance (or chroma) samples. Therefore, each CTU may be associated with one luminance sampling block and two chrominance sampling blocks. A size of one CTU is, for example, 128×128, 64×64, and 32×32. One CTU may further be divided into several CUs for coding. The CU may be a rectangular block or a square block. The CU may further be divided into a prediction unit (PU) and a transform unit (TU) so that coding, prediction, and transform separation are more flexible when processing. In an example, the CTU is divided into CUs in a quadtree manner, and the CU is divided into the TU and the PU in a quadtree manner.

The video coder and the video decoder may support various PU sizes. Assuming that a size of a particular CU is 2N×2N, the video coder and the video decoder may support a PU of 2N×2N or N×N for intra prediction, and support a symmetric PU of 2N×2N, 2N×N, N×2N, N×N, or a similar size for inter prediction. The video coder and the video decoder may further support asymmetric PUs of 2 N×nU, 2 N×nD, nL×2 N, and nR×2 N for inter prediction.

In some embodiments, as shown in FIG. 2, the video coder 200 may include: a PU 210, a residual unit 220, a transform/quantization unit 230, an inverse transform/quantization unit 240, a reconstruction unit 250, a loop filtering unit 260, a decoded picture buffer 270, and an entropy coding unit 280. The video coder 200 may contain more, fewer, or different functional components.

In some embodiments, in this disclosure, the current block may be referred to as a current CU, a current PU, or the like. A predicted block may alternatively be referred to as a predicted picture block or a picture prediction block, and a reconstructed picture block may alternatively be referred to as a reconstructed block or a picture reconstructed block.

In some embodiments, the PU 210 includes an inter prediction unit 211 and an intra prediction unit 212. Due to a strong correlation between adjacent pixels in a frame of a video, in a video coding and decoding technology, a spatial redundancy between adjacent pixels is eliminated using an intra prediction method. Due to a strong similarity between adjacent frames in a video, in the video coding and decoding technology, a temporal redundancy between adjacent frames is eliminated using an inter prediction method, thereby improving the coding efficiency.

The inter prediction unit 211 may be configured for inter prediction. The inter prediction may include motion estimation and motion compensation. The motion estimation may search a reference image in a reference image list to find a reference block of a to-be-coded picture block. The motion estimation may generate an index indicating the reference block and a motion vector indicating a spatial displacement between the to-be-coded picture block and the reference block. The motion estimation may output the index of the reference block and the motion vector as motion information of the to-be-coded picture block. The motion compensation may obtain prediction information of the to-be-coded picture block based on the motion information of the to-be-coded picture block. The inter prediction may refer to picture information of different frames. For the inter prediction, the reference block is found from a reference frame using the motion information, and a predicted block is generated according to the reference block to eliminate the temporal redundancy. A frame used in the inter prediction may be a P frame and/or a B frame. The P frame refers to a forward predicted frame, and the B frame refers to a bidirectional predicted frame. For the inter prediction, the reference block is found from the reference frame using the motion information, and a predicted block is generated according to the reference block. The motion information includes a reference frame list in which the reference frame is located, a reference frame index, and a motion vector. The motion vector may be either integer-pixel or fractional-pixel. If the motion vector is fractional-pixel, a needed fractional-pixel block needs to be made in the reference frame using interpolation filtering. The integer-pixel or fractional-pixel block in the reference frame found according to the motion vector is referred to as the reference block herein. In some technologies, the reference block is directly used as the predicted block. In some technologies, the predicted block is generated through further processing based on the reference block. Generating the predicted block through further processing based on the reference block may alternatively be understood as using the reference block as a predicted block and then processing based on the predicted block to generate a new predicted block.

The intra prediction unit 212 only refers to information of the same frame of picture to predict pixel information in a current coded picture block for eliminating the space redundancy. A frame used for the intra prediction may be an I frame.

The intra prediction has multiple prediction modes. Taking an international digital video coding standard H series as an example, the H.264/AVC standard has eight angular prediction modes and one non-angular prediction mode, and the H.265/HEVC extends to 33 angular prediction modes and two non-angular prediction modes. Intra prediction modes used in the HEVC include a planar mode, a direct current (DC) mode, and 33 angular modes, for a total of 35 prediction modes. Intra modes used in the VVC include a planar mode, a DC mode, and 65 angular modes, for a total of 67 prediction modes.

With the increase of angular modes, the intra prediction is more accurate and better conforms to requirements for the development of high-definition and ultra-high-definition digital videos.

The residual unit 220 may generate a residual block of the CU based on the pixel block of the CU and a predicted block of a PU of the CU. For example, the residual unit 220 may generate the residual block of the CU so that each sample in the residual block has a value equal to a difference between a sample in the pixel block of the CU and a corresponding sample in the predicted block of the PU of the CU.

The transform/quantization unit 230 may quantize a transform coefficient. The transform/quantization unit 230 may quantize, based on a quantization parameter (QP) value associated with the CU, a transform coefficient associated with a TU of the CU. The video coder 200 may adjust a quantization degree applied to a transform coefficient associated with the CU by adjusting the QP value associated with the CU. Illustratively, a residual video signal is converted into a transform domain through transform operations such as discrete Fourier transform (DFT) and discrete cosine transform (DCT). This is referred to as a transform coefficient. A lossy quantization operation is further performed on a signal in the transform domain, and some information is lost so that the quantized signal is conducive to compressed expression. In some video coding standards, more than one transform manners may be selected. Therefore, a coder side needs to select one of the transform manners for the current CU and inform a decoder side. Fineness of the quantization is generally determined by a quantization parameter (QP). A larger value of the QP indicates that coefficients in a larger value range are to be quantized into the same output, which therefore usually brings greater distortion and a lower bit rate. On the contrary, a smaller value of the QP indicates that coefficients in a smaller value range are to be quantized into the same output, which therefore usually brings less distortion and corresponds to a higher bit rate.

The inverse transform/quantization unit 240 may apply inverse quantization and inverse transform to the quantized transform coefficient to reconstruct a residual block from the quantized transform coefficient.

The reconstruction unit 250 may add samples of the reconstructed residual block to corresponding samples of one or more predicted blocks generated by the prediction unit 210 to generate a reconstructed picture block associated with the TU. In this manner, a sampling block of each TU of the CU is reestablished, and the video coder 200 may reconstruct a pixel block of the CU.

The loop filtering unit 260 is configured to process pixels obtained after inverse transform and inverse quantization to compensate for distortion information and provide a better reference for subsequent coded pixels. For example, a deblocking filtering operation may be performed to reduce blocking effects of pixel blocks associated with the CU. It can be known from the foregoing description that after a coded picture is subjected to operations of inverse quantization, inverse transformation, and prediction compensation, a reconstructed decoded picture may be obtained. Compared with the original picture, due to impact of quantization on the reconstructed picture, some information is different from that of the original picture, resulting in distortion. Performing filtering operations on the reconstructed picture, such as a deblocking filter (DBF), a sample adaptive offset (SAO), or an adaptive loop filter (ALF), may effectively reduce the distortion caused by quantization. Since these filtered reconstructed pictures are used as references for subsequent coded pictures to predict future signals, the foregoing filtering operation is also referred to as loop filtering and a filtering operation in a coding loop.

The decoded picture buffer 270 may store reconstructed pixel blocks. The inter prediction unit 211 may perform inter prediction on a PU of another picture using a reference picture containing the reconstructed pixel block. In addition, the intra prediction unit 212 may perform intra prediction on another PU in the same picture as the CU using the reconstructed pixel block in the decoded picture buffer 270.

The entropy coding unit 280 may receive the quantized transform coefficient from the transform/quantization unit 230. The entropy coding unit 280 may perform one or more entropy coding operations on the quantized transform coefficient to generate entropy-coded data. Illustratively, statistical compression coding is performed on quantized transform domain signals according to frequencies of occurrence of values, and finally, a binarized (0 or 1) compressed code stream is outputted. In addition, entropy coding also needs to be performed on other information generated through coding, such as a selected mode and a motion vector, to reduce a bit rate. In one example, statistical coding is a lossless coding mode and may effectively reduce a bit rate needed for expressing the same signal. Common statistical coding modes include variable length coding (VLC) or content adaptive binary arithmetic coding (CABAC).

FIG. 3 is a schematic block diagram of a video decoder according to an embodiment of this disclosure.

As shown in FIG. 3, the video decoder 300 includes: an entropy decoding unit 310, a PU 320, an inverse quantization/transform unit 330, a reconstruction unit 340, a loop filtering unit 350, and a decoded picture buffer 360. The video decoder 300 may contain more, fewer, or different functional components.

The video decoder 300 may receive a code stream. The entropy decoding unit 310 may parse the code stream to extract syntax elements from the code stream. As a part of parsing the code stream, the entropy decoding unit 310 may parse an entropy-coded syntax element in the code stream. The prediction unit 320, the inverse quantization/transform unit 330, the reconstruction unit 340, and the loop filtering unit 350 may decode the video data according to the syntax element extracted from the code stream, i.e., generating decoded video data.

In some embodiments, the prediction unit 320 includes an intra prediction unit 322 and an inter prediction unit 321.

The intra prediction unit 322 may perform intra prediction to generate a predicted block of the PU. The intra prediction unit 322 may use an intra prediction mode to generate the predicted block of the PU based on a pixel block of a spatial adjacent PU. The intra prediction unit 322 may further determine the intra prediction mode of the PU according to one or more syntax elements parsed from the code stream.

The inter prediction unit 321 may construct a first reference picture list (list 0) and a second reference picture list (list 1) according to the syntax element parsed from the code stream. In addition, if the PU uses the inter prediction coding, the entropy decoding unit 310 may parse motion information of the PU. The inter prediction unit 321 may determine one or more reference blocks of the PU according to the motion information of the PU. The inter prediction unit 321 may generate a predicted block of the PU according to one or more reference blocks of the PU.

The inverse quantization/transform unit 330 may perform inverse quantization (i.e., dequantization) on a transform coefficient associated with the TU. The inverse quantization/transform unit 330 may determine a quantization degree using a QP value associated with a CU of the TU.

After the inverse quantization is performed on the transform coefficient, the inverse quantization/transform unit 330 may apply one or more inverse transforms to an inverse-quantized transform coefficient to generate a residual block associated with the TU.

The reconstruction unit 340 reconstructs a pixel block of the CU using the residual block associated with the TU of the CU and the predicted block of the PU of the CU. For example, the reconstruction unit 340 may add a sample of the residual block to a corresponding sample of the predicted block to reconstruct a pixel block of the CU, so as to obtain a reconstructed picture block.

The loop filtering unit 350 may perform a deblocking filtering operation to reduce blocking effects of pixel blocks associated with the CU.

The video decoder 300 may store the reconstructed picture of the CU in the decoded picture buffer 360. The video decoder 300 may use the reconstructed picture in the decoded picture buffer 360 as a reference picture for subsequent prediction, or transmit the reconstructed picture to a display apparatus for presentation.

A basic procedure of video coding and decoding is as follows. At the coder side, a frame of picture is divided into blocks, and for a current block, the prediction unit 210 generates a predicted block of the current block using intra prediction or inter prediction. The residual unit 220 may calculate a residual block based on the predicted block and an original block of the current block, i.e., a difference between the predicted block and the original block of the current block. The residual block may alternatively be referred to as residual information. The residual block is transformed and quantized through the transform/quantization unit 230 so that information insensitive to human eyes may be removed to eliminate visual redundancy. In some embodiments, a residual block before being transformed and quantized through the transform/quantization unit 230 may be referred to as a time domain residual block, and a time domain residual block after being transformed and quantized through the transform/quantization unit 230 may be referred to as a frequency residual block or a frequency domain residual block. The entropy coding unit 280 receives a quantized transform coefficient outputted by the transform/quantization unit 230, and may then perform entropy coding on the quantized transform coefficient to output a code stream. For example, the entropy coding unit 280 may eliminate character redundancy according to a target context model and probability information of a binary code stream.

At the decoder side, the entropy decoding unit 310 may parse the code stream to obtain prediction information, a quantization coefficient matrix, and the like of the current block. The prediction unit 320, based on the prediction information, generates the predicted block of the current block using intra prediction or inter prediction on the current block. The inverse quantization/transform unit 330 uses the quantization coefficient matrix obtained from the code stream to perform inverse quantization and inverse transform on the quantization coefficient matrix to obtain the residual block. The reconstruction unit 340 adds the predicted block and the residual block to obtain a reconstructed block. The reconstructed blocks form the reconstructed picture, and the loop filtering unit 350 performs loop filtering on the reconstructed picture based on the picture or based on the blocks to obtain a decoded picture. The coder side also needs an operation similar to that of the decoder side to obtain the decoded picture. The decoded picture may alternatively be referred to as a reconstructed picture, and the reconstructed picture may be a subsequent frame used as a reference frame for inter prediction.

Block division information determined by the coder side, and mode information or parameter information such as prediction, transform, quantization, entropy coding, loop filtering, and the like are carried in the code stream when necessary. The decoder side parses the code stream and analyzes the code stream according to existing information to determine block division information, and mode information or parameter information such as prediction, transform, quantization, entropy coding, loop filtering, and the like that are the same as those of the coder side, thereby ensuring that the decoded picture obtained by the coder side is the same as that of the decoded picture obtained by the decoder side.

The foregoing description is an example of a basic procedure of a video codec in a block-based hybrid coding framework. With the development of technologies, some modules or operations of the framework or the procedure may be optimized. This disclosure is applicable to the basic procedure of the video codec in the block-based hybrid coding framework, but is not limited to the framework and the procedure.

In a related hybrid coding framework, each frame of picture in a video is usually first segmented into units of a particular size, and then a subsequent coding and decoding procedure is performed. As shown in FIG. 4, the LCU is a basic CU in the hybrid coding framework and usually contains two parts: luminance Y and chrominance UV. Since the U component and the V component in the chrominance have similar characteristics, the U component and the V component are usually sequentially processed according to an order of U first and then V using the same coding parameter, and coding results of U and V are correspondingly obtained.

The related hybrid coding framework uses a conventional loop filter to suppress the distortion of a reconstructed picture, thereby improving the quality of the reconstructed picture. In addition, this framework expects to restore a coded reconstructed picture to an original picture. However, a conventional loop filter is based on manual design, which makes it difficult to effectively reduce the distortion of the reconstructed picture, leaving a relatively large optimization space. Since deep learning tools have excellent performance in picture processing, a deep learning-based loop filter is applied to a loop filter module.

A technology involved in this disclosure is a neural network loop filter (NNLF). As shown in FIG. 5, a to-be-filtered picture before the filtering is inputted into a trained filter to obtain an augmented picture after the filtering.

In a training process, the neural network usually uses a loss function to constrain a filtered picture so that the picture is restored to the original picture as much as possible. The loss function measures a difference between a filtered value and a true value. A larger loss value indicates a larger difference, and a training target is to reduce the loss. For a deep learning-based coding tool, for example, a common loss function includes: an L1 norm loss function, an L2 norm loss function, and a smooth L1 loss function.

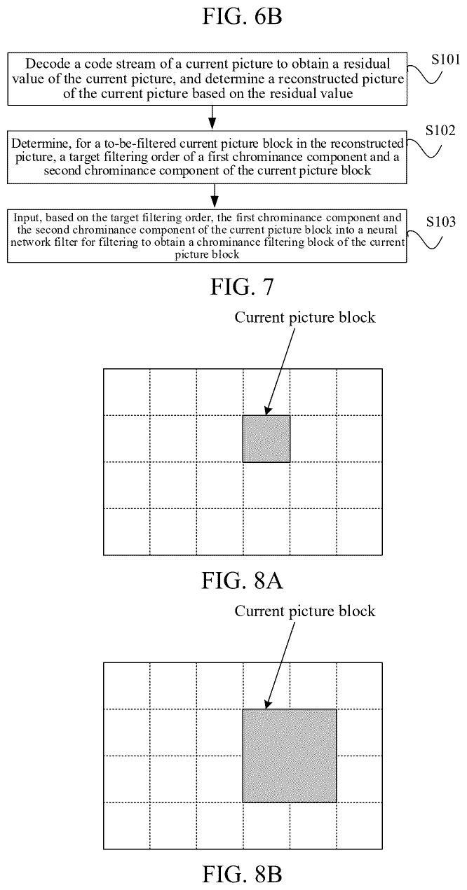

In a training process of the neural network filter, usually, UV components of chrominance are inputted using the LCU as a unit, and filtering results of the U component and the V component are correspondingly outputted. Then, the filtering results of the U component and the V component are constrained using a loss function to enable the picture to be restored to the original picture. After the training process ends, parameters of the neural network filter are fixed. To maintain consistency of training and testing, a testing process of the neural network filter usually adopts a chrominance filtering order the same as that in the training process. Illustratively, as shown in FIG. 6A, in the training process of the neural network filter, the U component of the LCU is first inputted into the neural network filter, and then the V component of the LCU is inputted into the neural network filter to obtain a filtered value of the U component of the LCU and a filtered value of the V component of the LCU. Next, a loss of the U component is determined based on the filtered value of the U component of the LCU and an original value of the U component of the LCU, and a loss of the V component is determined based on the filtered value of the V component of the LCU and an original value of the V component of the LCU. Finally, the parameters of the neural network filter are adjusted based on the loss of the U component and the loss of the V component to train the neural network filter. Correspondingly, as shown in FIG. 6B, in the testing process of the neural network filter, the U component of the LCU is also first inputted into the neural network filter, and then the V component of the LCU is inputted into the neural network filter for filtering to obtain a filtered value of the U component of the LCU and a filtered value of the V component of the LCU.

However, since the U component and the V component in the chrominance have similar characteristics, the learning of filtering of the chrominance component by the neural network filter has a particular similarity. Strictly stipulating that a chrominance filtering order in the testing process keeps consistency with that in the training process may limit the generalization of the neural network filter, leaving an optimization space.

To resolve the foregoing technical problem, in the embodiments of this disclosure, when a current picture is decoded, a reconstructed picture of the current picture is first determined. For a to-be-filtered current picture block in the reconstructed picture, a target filtering order of a first chrominance component and a second chrominance component of the current picture block is determined, where the target filtering order is determined based on filtering costs of N filtering orders, and N is a positive integer greater than 1. Next, based on the target filtering order, the first chrominance component and the second chrominance component of the current picture block are inputted into the neural network filter for filtering to obtain a filtered picture block of the current picture block. That is, in this embodiment of this disclosure, the target filtering order in which the first chrominance component and the second chrominance component of the current picture block are inputted into the neural network filter is determined based on the filtering costs of the N filtering orders, rather than using a training order by default. In this way, the accuracy of selecting the target filtering order may be improved. When the first chrominance component and the second chrominance component of the current picture block are inputted into the neural network filter for filtering based on the determined target filtering order, the filtering effect may be improved, thereby improving the generalization of the neural network filter and improving the decoding performance.

Examples of technical solutions of the embodiments of this disclosure are described in further detail in the following through some embodiments. The following several embodiments may be mutually combined, and same or similar concepts or processes may not be repeatedly described in some embodiments.

First, taking a decoder side as an example, a picture filtering method provided by an embodiment of this disclosure is introduced.

FIG. 7 is a schematic flowchart of a picture filtering method according to an embodiment of this disclosure. This embodiment of this disclosure is applied to the decoder or decoding device shown in FIG. 1 or FIG. 3. As shown in FIG. 7, the method provided in this embodiment of this disclosure includes the following operations.

S101: decode a code stream of a current picture to obtain a residual value of the current picture, and determine a reconstructed picture of the current picture based on the residual value. In an example, a current picture encoded in a coded bitstream is reconstructed.

In this embodiment of this disclosure, when coding the current picture, a coder side divides the current picture into coding blocks and performs block-by-block coding using the coding block as a CU. For example, for a to-be-coded current block in the current picture, a prediction value of the current block is first obtained in an inter and/or intra prediction manner. Then, a residual value of the current block is obtained based on the predicted value of the current block and the current block. The coder side transforms the residual value of the current block to obtain a transform coefficient. In one example, the coder side does not quantize the transform coefficient of the current block and directly codes the transform coefficient to obtain the code stream. In another example, the coder side quantizes the transform coefficient of the current block to obtain a quantized coefficient, and then codes the quantized coefficient to obtain the code stream.

In a coding process, as shown in FIG. 2, the coder side further performs inverse transform on the transform coefficient to obtain a residual value, and adds the residual value and the predicted value to obtain a reconstructed value of the current block. Based on the foregoing operations, reconstructed values of coding blocks in the current picture may be obtained, and these reconstructed values form the reconstructed picture of the current picture. Next, to further improve the quality of the reconstructed picture, the reconstructed picture is filtered to obtain a decoded picture of the current picture. In an example, the decoded picture may be stored in a decoding buffer for subsequent picture prediction.

As shown in FIG. 3, for each to-be-decoded block, for example, the current block, in the current picture, after obtaining the code stream, a decoder side decodes the code stream to obtain the transform coefficient of the current block. In an example, if the coder side quantizes the transform coefficient and codes the transform coefficient to form the code stream, the decoder side obtains the code stream and decodes the code stream to obtain the quantized coefficient of the current block, and then performs inverse quantization on the quantized coefficient to obtain a transform coefficient of the current picture. Next, the decoder side performs inverse transform on the transform coefficient of the current block to obtain the residual value of the current block. Meanwhile, the decoder side obtains the predicted value of the current block through prediction in an inter and/or intra prediction manner. In this way, the predicted value and the residual value of the current block are added to obtain the reconstructed value of the current block. Based on the foregoing operations, the decoder side may determine, through decoding, reconstructed values of to-be-decoded blocks in the current picture, and these reconstructed values form the reconstructed picture of the current picture. Next, to further improve the quality of the reconstructed picture, the decoder side filters the reconstructed picture to obtain the decoded picture of the current picture. In an example, the decoder side may store the decoded picture in the decoding buffer for subsequent picture prediction. In an example, the decoder side may output the decoded picture to a display device for display.

In some embodiments, the picture filtering method proposed by this embodiment of this disclosure may be configured for filtering at least one frame of picture in a video. That is, the foregoing current picture is a picture in the video.

In some embodiments, the picture filtering method proposed by this embodiment of this disclosure may be configured for decoding a single picture. That is, the foregoing current picture is an independent picture, for example, a picture generated by an electronic device.

After obtaining the reconstructed picture of the current picture based on the foregoing operations, the decoder side performs the following operation of S102.

S102: determine, for a to-be-filtered current picture block in the reconstructed picture, a target filtering order of a first chrominance component and a second chrominance component of the current picture block. In an example, a target filtering order, for a current block in the reconstructed current picture, is determined from a plurality of filtering orders of a first chrominance component and a second chrominance component of the current block.

The target filtering order is determined by decoding the code stream or based on filtering costs of N filtering orders, and N is a positive integer greater than 1.

In this embodiment of this disclosure, to improve the quality of the reconstructed picture, the reconstructed picture is filtered. Specifically, the reconstructed picture is filtered using a neural network filter. When the reconstructed picture is filtered, the reconstructed picture is divided into at least one picture block, and each picture block is filtered separately. Processes in which the decoder side filters the picture blocks in the reconstructed picture using the neural network filter are basically consistent. For ease of description, filtering the current picture block in the reconstructed picture is used as an example herein for description.

The size and shape of the foregoing current picture block are not limited in this embodiment of this disclosure.

In one possible implementation, the foregoing to-be-filtered current picture block is at least one CTU of the reconstructed picture. That is, at least one CTU of the reconstructed picture is divided into a picture block and inputted into the neural network filter for filtering.

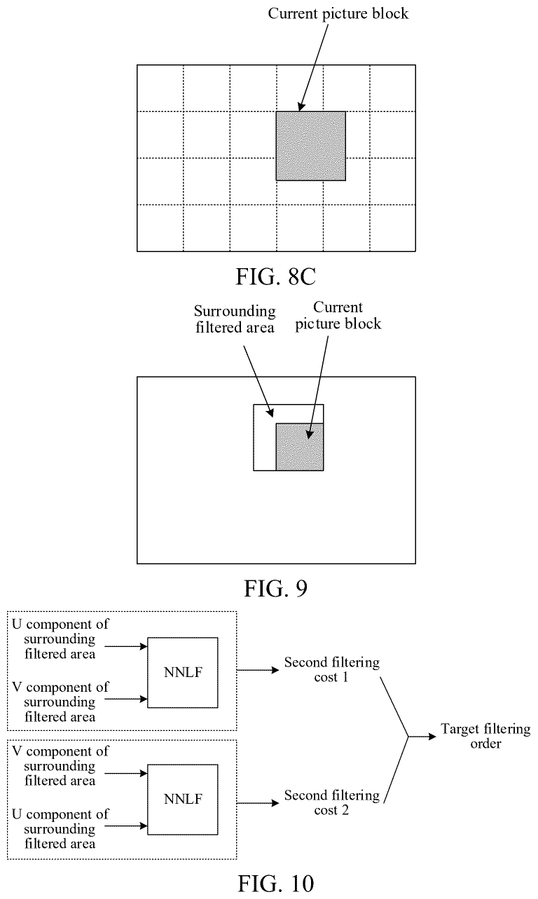

In some examples, as shown in FIG. 8A, the current picture block is a CTU of the reconstructed picture, that is, a CTU of the reconstructed picture is used as an input picture block of the neural network filter.

In another example, as shown in FIG. 8B, the current picture block is four CTUs of the reconstructed picture, that is, the four CTUs of the reconstructed picture are used as an input picture block of the neural network filter.

In an example, a plurality of CTUs such as two CTUs or three CTUs of the reconstructed picture may further be used as an input picture block of the neural network filter. The plurality of CTUs may be a plurality of CTUs in a horizontal direction or a plurality of CTUs in a vertical direction. In some embodiments, the plurality of CTUs may be adjacent, or not adjacent, or some are adjacent, and some are not adjacent.

In another possible implementation, the foregoing to-be-filtered current picture block is a preset picture area of the reconstructed picture. That is, a preset picture area of the reconstructed picture is used as an input picture block of the neural network filter.

A specific shape and size of the preset picture area are not limited in this embodiment of this disclosure.

In an example, as shown in FIG. 8C, the preset picture area includes at least one missing number of CTUs of the reconstructed picture, that is, the at least one missing number of CTUs of the reconstructed picture is used as an input picture block of the neural network filter.

In some embodiments, the foregoing preset picture area is a fixed area. For example, during each filtering process, the to-be-filtered current picture block in the reconstructed picture is obtained according to the preset picture area, and the picture block is used as an input picture block of the neural network filter. In this case, the sizes and shapes of the picture blocks inputted into the neural network filter are the same, and the picture blocks each are a preset picture area.

In some embodiments, the preset picture area is a change value. For example, during the first filtering, a to-be-filtered picture block in the reconstructed picture is obtained according to a first preset picture area and inputted as an input picture block into the neural network filter for filtering. During the second filtering, a to-be-filtered picture block in the reconstructed picture is obtained according to a second preset picture area and inputted as an input picture block into the neural network filter for filtering, and so on. In an example of this embodiment, the decoder side may divide the reconstructed picture into several to-be-filtered picture blocks. Shapes and sizes of the several to-be-filtered picture blocks may be the same or different, or may be partially the same or partially different.

After determining the to-be-filtered current picture block in the reconstructed picture based on the foregoing operations, the decoder side filters the current picture block using the neural network filter.

The current picture block includes luminance components and chrominance components, and the chrominance component includes a U component and a V component. Since the U component and the V component in the chrominance have similar characteristics, the same neural network filter is usually used for filtering.

It can be known from the foregoing description that currently, when the chrominance components are filtered, a filtering order of the chrominance components is fixed and is usually consistent with an input order of the chrominance components during training of the neural network filter. For example, during training, the U component and the V component are inputted into the neural network filter in an order that the U component precedes the V component to train the neural network filter. In this way, in an actual filtering process, the U component and the V component are inputted into the neural network filter for filtering according to a filtering order in which the U component precedes the V component. However, when filtering is performed by keeping the filtering order of the chrominance components the same as the training order, a poor filtering effect is caused, and the generalization of the neural network filter is reduced.

To resolve the technical problem, in the embodiments of this disclosure, when the chrominance components of the current picture block are filtered, the target filtering order of the first chrominance component and the second chrominance component of the current picture block is first determined. The target filtering order is determined based on filtering costs of N filtering orders so that the accuracy of determining the target filtering order may be improved. In this way, when the chrominance components of the current picture block are filtered based on the determined target filtering order, the filtering effect of the chrominance components may be effectively improved, thereby improving the generalization of the neural network filter.

The filtering cost in this embodiment of this disclosure includes at least one of a calculation cost and a distortion cost. That is, in some embodiments, the filtering cost of the filtering order in this embodiment of this disclosure includes a calculation cost of the filtering order. For example, higher calculation time and/or calculation complexity indicates a larger calculation cost. In some embodiments, the filtering cost of the filtering order in this embodiment of this disclosure includes a distortion cost of the filtering order. For example, a higher distortion degree indicates a larger distortion cost. In some embodiments, the filtering cost of the filtering order in this embodiment of this disclosure includes the calculation cost and the distortion cost of the filtering order. For example, a larger sum of the distortion cost and the calculation cost indicates a larger filtering cost.

A specific process in which the decoder side determines the target filtering order of the first chrominance component and the second chrominance component of the current picture block is described below.

In this embodiment of this disclosure, specific manners in which the decoder side determines the target filtering order include, but are not limited to, the following several manners.

First manner: the decoder side obtains the target filtering order by decoding the code stream. In this case, determining the target filtering order of the first chrominance component and the second chrominance component of the current picture block in S102 includes the following operations of S102-A1 and S102-A2.

S102-A1: decode the code stream to obtain first information, the first information being configured for indicating the target filtering order.

S102-A2: obtain the target filtering order based on the first information.

In the first manner, the coder side determines the target filtering order of the first chrominance component and the second chrominance component of the current picture block, then writes the first information into the code stream, and indicates the target filtering order through the first information. In this way, the decoder side obtains the first information by decoding the code stream, and further obtains the target filtering order based on the first information.

A specific expression form of the first information is not limited in this embodiment of this disclosure, as long as it is any syntax field that may indicate the target filtering order.

In some embodiments, the foregoing first information includes a first flag, and the target filtering order is indicated using different values of the first flag.

Illustratively, a correspondence between the value of the first flag and the filtering order of the chrominance components is shown in Table 1.

TABLE 1

| Value of | |
|---|---|
| first flag | Filtering order |
| A1 | U precedes V |
| A2 | V precedes U |
| . . . | . . . |

Specific values of A1, A2, and the like are not limited in this embodiment of this disclosure. For example, A1 is equal to 0, A2 is equal to 1, or A1 is equal to 1, and A2 is equal to 0.

A specific type of the filtering order of the chrominance components is not limited in this embodiment of this disclosure. For example, in addition to the two filtering orders, i.e., U preceding V and V preceding U, shown in Table 1, at least the following filtering orders may be included.

Example 1: the filtering orders of the chrominance components include that the U component is divided into a plurality of sub-U components, and the plurality of sub-U components and the V component form multiple filtering orders.

For example, the U component is divided into a first sub-U component and a second sub-U component. In this way, the filtering orders formed by the first sub-U component, the second sub-U component, and the V component include: the first sub-U component, then the V component, and finally the second sub-U component; the second sub-U component, then the V component, and finally the first sub-U component; the second sub-U component, then the first sub-U component, and finally the V component; the V component, then the second sub-U component, and finally the first sub-U component, and so on.

Example 2: the filtering orders of the chrominance components include that the V component is divided into a plurality of sub-V components, and the plurality of sub-V components and the U component form multiple filtering orders.

For example, the V component is divided into a first sub-V component and a second sub-V component. In this way, the filtering orders formed by the first sub-V component, the second sub-V component, and the U component include: the first sub-V component, then the U component, and finally the second sub-V component; the second sub-V component, then the U component, and finally the first sub-V component; the second sub-V component, then the first sub-V component, and finally the U component; the U component, then the second sub-V component, and finally the first sub-V component, and so on.

Example 3: the filtering orders of the chrominance components include that the U component is divided into a plurality of sub-U components, the V component is divided into a plurality of sub-V components, and the plurality of sub-U components and the plurality of sub-V components form multiple filtering orders.

For example, the U component is divided into the first sub-U component and the second sub-U component, and the V component is divided into the first sub-V component and the second sub-V component. In this way, the filtering orders formed by the first sub-U component, the second sub-U component, the first sub-V component, and the second sub-V component include: the first sub-U component, the first sub-V component, the second sub-U component, and finally the second sub-V component; the first sub-V component, the first sub-U component, the second sub-V component, and finally the second sub-U component; the second sub-V component, the first sub-U component, the first sub-V component, and finally the second sub-U component, and so on.

In the first manner, the coder side may determine the value of the first flag corresponding to the target filtering order based on Table 1, set the value of the first flag to this value, and then write the first flag into the code stream. In this way, the decoder side obtains the first flag by decoding the code stream, and further obtains the target filtering order of the first chrominance component and the second chrominance component of the current picture block by looking up Table 1 according to the value of the first flag.

In an example, assuming that the first chrominance component is the U component, and the second chrominance component is the V component, if the coder side determines that the target filtering order of the first chrominance component and the second chrominance component of the current picture block is that the first chrominance component precedes the second chrominance component, based on Table 1, the coder side may determine that the value of the first flag is A1, and then write the first flag into the code stream after setting the first flag to A1. In this way, the decoder side decodes the code stream to obtain the first flag, and further determines, based on the value of the first flag and by looking up Table 1, that the target filtering order of the first chrominance component and the second chrominance component of the current picture block is that the first chrominance component precedes the second chrominance component.

In another example, assuming that the first chrominance component is the U component, and the second chrominance component is the V component, if the coder side determines that the target filtering order in which the first chrominance component and the second chrominance component of the current picture block are inputted into the neural network filter is that the second chrominance component precedes the first chrominance component, based on Table 1, the coder side may determine that the value of the first flag is A2, and then write the first flag into the code stream after setting the first flag to A2. In this way, the decoder side decodes the code stream to obtain the first flag, and further determines, based on the value of the first flag and by looking up Table 1, that the target filtering order of the first chrominance component and the second chrominance component of the current picture block is that the second chrominance component precedes the first chrominance component.

In some embodiments, the foregoing filtering cost includes a first filtering cost, the foregoing target filtering order is determined based on a first filtering cost of each of the N filtering orders, and the first filtering cost of the filtering order is a filtering cost determined when the first chrominance component and the second chrominance component of the current picture block are inputted into the neural network filter for filtering according to the filtering order,

That is, in this embodiment, for each of the N filtering orders, the coder side inputs the first chrominance component and the second chrominance component of the current picture block into the neural network filter for filtering according to the filtering order, determines a filtering cost corresponding to the filtering order, and records the filtering cost as the first filtering cost. Specific types of the foregoing N filtering orders are not limited in this embodiment of this disclosure. For example, the N filtering orders include some or all of the filtering orders shown in Table 1.

Illustratively, for a j-th filtering order in the N filtering orders, the coder side inputs the first chrominance component and the second chrominance component of the current picture block into the neural network filter for filtering according to the j-th filtering order to obtain a filtered value of the first chrominance component and a filtered value of the second chrominance component of the current picture block. For ease of description, the filtered value of the chrominance component of the current picture block is recorded as a j-th filtered value. In this case, the j-th filtered value includes the filtered value of the first chrominance component and the filtered value of the second chrominance component of the current picture block in the j-th filtering order.

Next, the coder side determines a first filtering cost corresponding to the j-th filtering order based on the j-th filtered value of the current picture block and an original picture block of the current picture block. For example, the first filtering cost corresponding to the j-th filtering order is determined based on the filtered value of the first chrominance component of the current picture block, a first chrominance component of the original picture block of the current picture block, the filtered value of the second chrominance component of the current picture block, and a second chrominance component of the original picture block of the current picture block in the j-th filtering order.

A specific calculation manner of the first filtering costs is not limited in this embodiment of this disclosure. For example, the foregoing first filtering cost may be rate-distortion optimization (RDO) or an approximate cost such as a sum of squared differences (SSD), a sum of transform absolute differences (STAD), or a sum of absolute differences (SAD).

Based on the foregoing operations, the coder side may determine first filtering costs corresponding to the N filtering orders, and further determine the target filtering order from the N filtering orders based on the first filtering costs corresponding to the filtering orders.

In some embodiments, the target filtering order is a filtering order having a smallest first filtering cost in the N filtering orders. That is, the coder side determines the filtering order having the smallest first filtering cost in the N filtering orders as the target filtering order of the chrominance components of the current picture block, and further indicates the target filtering order to the decoder side.

It can be known from the foregoing description that, in the first manner, the decoder side may quickly obtain the target filtering order of the first chrominance component and the second chrominance component of the current picture block by decoding the code stream, thereby improving a picture filtering speed.

In addition to determining the target filtering order using the method in the foregoing first manner, the decoder side may further determine the target filtering order using a method in the following second manner.

Second manner: the decoder side automatically determines the target filtering order. In this case, determining the target filtering order of the first chrominance component and the second chrominance component of the current picture block in S102 includes the following operations of S102-B1 to S102-B3.

S102-B1: determine a surrounding filtered area of the current picture block.

S102-B2: input, for an i-th filtering order in the N filtering orders, a first chrominance component and a second chrominance component of the surrounding filtered area into the neural network filter for filtering according to the i-th filtering order to determine an i-th second filtering cost of the surrounding filtered area in the i-th filtering order, i being a positive integer less than or equal to N.

S102-B3: determine the target filtering order from the N filtering orders based on second filtering costs corresponding to the N filtering orders.

In the second manner, the decoder side determines the target filtering order from the N filtering orders based on a surrounding filtered area of the current picture block.

The size and shape of the surrounding filtered area of the current picture block are not limited in this embodiment of this disclosure.

In some embodiments, the surrounding filtered area of the current picture block is a filtered area that is around the current picture block and adjacent to the current picture block.

In some embodiments, as shown in FIG. 9, a surrounding filtered area of the current picture block includes an upper filtered area and a left filtered area of the current picture block.

In some embodiments, the surrounding filtered area of the current picture block includes a template area of the current picture.

After determining the surrounding filtered area of the current picture block in the current picture, the decoder side performs the foregoing operation of S102-B2, inputs the first chrominance component and the second chrominance component of the surrounding filtered area into the neural network filter for filtering according to each of the N filtering orders, determines a filtering cost corresponding to each of the N filtering orders, and records the filtering cost as a second filtering cost. In this embodiment, specific processes in which the decoder side determines second filtering costs corresponding to the N filtering orders are basically the same. An i-th filtering order in the N filtering orders is used as an example for description. That is, the first chrominance component and the second chrominance component of the surrounding filtered area are inputted into the neural network filter for filtering according to the i-th filtering order to determine the i-th second filtering cost of the surrounding filtered area in the i-th filtering order.

A specific manner of determining the i-th second filtering cost of the surrounding filtered area in the i-th filtering order is not limited in this embodiment of this disclosure.

In a possible implementation, the decoder side inputs the first chrominance component and the second chrominance component of the surrounding filtered area into the neural network filter for filtering according to the i-th filtering order to obtain a filtered value of the first chrominance component of the surrounding filtered area in the i-th filtering order and a filtered value of the second chrominance component in the i-th filtering order. Further, the second filtering cost corresponding to the i-th filtering order is determined based on the filtered value of the first chrominance component of the surrounding filtered area in the i-th filtering order and the filtered value of the second chrominance component in the i-th filtering order. For example, if the second filtering cost includes a calculation cost, the decoder side determines a calculation cost when the first chrominance component and the second chrominance component of the surrounding filtered area are filtered through the neural network filter in the i-th filtering order, and further determines, based on the calculation cost, the second filtering cost corresponding to the i-th filtering order.

In a possible implementation, S102-B2 includes the following operations of S102-B21 and S102-B22.

S102-B21: input the first chrominance component and the second chrominance component of the surrounding filtered area into the neural network filter for filtering according to the i-th filtering order to obtain an i-th filtered value of the surrounding filtered area.

S102-B22: determine the i-th second filtering cost based on the i-th filtered value and the surrounding filtered area.

In this implementation, the decoder side inputs the first chrominance component and the second chrominance component of the surrounding filtered area into the neural network filter for filtering according to the i-th filtering order to obtain the filtered value of the first chrominance component of the surrounding filtered area in the i-th filtering order and the filtered value of the second chrominance component in the i-th filtering order. For ease of description, the filtered value of the first chrominance component of the surrounding filtered area in the i-th filtering order and the filtered value of the second chrominance component in the i-th filtering order are recorded as the i-th filtered value of the surrounding filtered area.

Next, the second filtering cost corresponding to the i-th filtering order is determined based on the i-th filtered value and the surrounding filtered area.

For example, if the second filtering cost includes a distortion cost, the decoder side determines the second filtering cost corresponding to the i-th filtering order based on the filtered value of the first chrominance component of the surrounding filtered area, the first chrominance component of the surrounding filtered area, the filtered value of the second chrominance component of the surrounding filtered area, and the second chrominance component of the surrounding filtered area in the i-th filtering order.

A specific calculation manner of the second filtering costs is not limited in this embodiment of this disclosure. For example, the foregoing second filtering cost may be RDO or an approximate cost such as SSD, STAD, or SAD.

For another example, if the second filtering cost includes the calculation cost and the distortion cost, the decoder side determines the distortion cost corresponding to the i-th filtering order based on the filtered value of the first chrominance component of the surrounding filtered area, the first chrominance component of the surrounding filtered area, the filtered value of the second chrominance component of the surrounding filtered area, and the second chrominance component of the surrounding filtered area in the i-th filtering order. Meanwhile, a calculation cost when the first chrominance component and the second chrominance component of the surrounding filtered area are filtered through the neural network filter in the i-th filtering order is determined. In this way, the second filtering cost corresponding to the i-th filtering order is determined according to the distortion cost and the calculation cost corresponding to the i-th filtering order. For example, a sum or a weighted sum of the distortion cost and the calculation cost corresponding to the i-th filtering order is determined as the second filtering cost corresponding to the i-th filtering order.

Based on the foregoing operations, the decoder side may determine second filtering costs of the surrounding filtered area of the current picture block in the N filtering orders. Further, the target filtering order is determined from the N filtering orders based on the second filtering costs corresponding to the N filtering orders.

A specific manner in which the decoder side determines the target filtering order from the N filtering orders based on the second filtering costs corresponding to the N filtering orders is not limited in this embodiment of this disclosure.

For example, a filtering order having a smallest second filtering cost in the N filtering orders is determined as the target filtering order.

For another example, any one of the N filtering orders having a second filtering cost less than a preset value is determined as the target filtering order.

Specific types of the foregoing N filtering orders are not limited in this embodiment of this disclosure.

In an example, the N filtering orders are shown in Table 2.

TABLE 2

| | |
|---|---|
| First filtering order | U precedes V |
| Second filtering order | V precedes U |
| Third filtering order | ½U, then V, |
| | and finally ½U |
| . . . | . . . |

In some embodiments, the N filtering orders include a first filtering order and a second filtering order. The first filtering order is that the first chrominance component precedes the second chrominance component in inputs of the neural network filter, that is, when the first chrominance component and the second chrominance component are inputted into the neural network filter, the first chrominance component precedes the second chrominance component. The second filtering order is that the second chrominance component precedes the first chrominance component in the inputs of the neural network filter, that is, when the first chrominance component and the second chrominance component are inputted into the neural network filter, the second chrominance component precedes the first chrominance component.

In this case, as shown in FIG. 10, the decoder side inputs, according to the first filtering order, the first chrominance component (for example, the U component) and the second chrominance component (for example, the V component) of the surrounding filtered area into the neural network filter for filtering to determine a second filtering cost 1 corresponding to the first filtering order. Meanwhile, the decoder side inputs, according to the second filtering order, the first chrominance component and the second chrominance component of the surrounding filtered area into the neural network filter for filtering to determine a second filtering cost 2 corresponding to the first filtering order. Finally, the target filtering order is selected from the first filtering order and the second filtering order according to the second filtering cost 1 corresponding to the first filtering order and the second filtering cost 2 corresponding to the second filtering order. For example, a filtering order having the smallest second filtering cost in the first filtering order and the second filtering order is determined as the target filtering order.

It can be known from the foregoing description that, in this embodiment of this disclosure, when the target filtering order of the chrominance components of the current picture block is determined, a training order of the chrominance components of the neural network filter is not considered. That is, regardless of the training order of the chrominance components of the neural network filter, the decoder side determines the target filtering order of the chrominance components of the current chrominance block according to the foregoing operations.

A training manner of the neural network filter and related training parameters are not limited in this embodiment of this disclosure.

In some embodiments, the neural network filter is obtained by training with at least one CTU as a training unit. That is, at least one CTU of a training picture is divided into a training unit and inputted into the neural network filter to train the neural network filter.

In some embodiments, the neural network filter is obtained by training with the preset picture area as the training unit. That is, the preset picture area of the training picture is divided into a training unit and inputted into the neural network filter to train the neural network filter. Related descriptions of the foregoing preset picture area may refer to related descriptions of the foregoing preset picture area, and details are not described herein again.

In some embodiments, a training order of chrominance components of the neural network filter is any one of N training orders. In some embodiments, the foregoing N training orders and N filtering orders may be the same or different, or may be partially the same or partially different.

In some embodiments, the foregoing N training orders include a first training order and a second training order. The first training order is that the first chrominance component precedes the second chrominance component in the inputs of the neural network filter, and the second training order is that the second chrominance component precedes the first chrominance component in the inputs of the neural network filter.

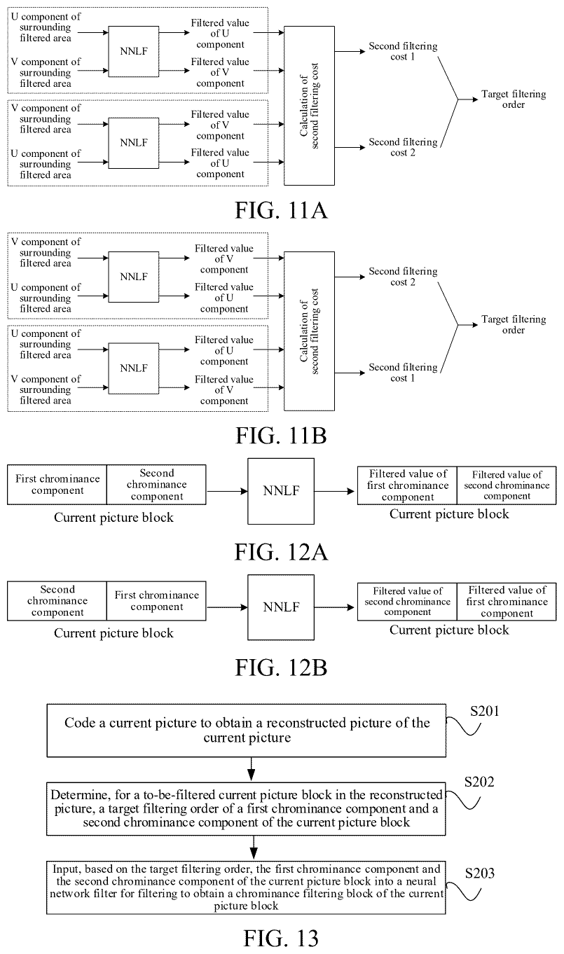

In an example, in a training process, a chrominance training order of the neural network filter is a first training order. For example, the U component and the V component are sequentially inputted, and filtering results of the U component and the V component are correspondingly constrained using loss functions to train the neural network filter. The target filtering order of the first chrominance component and the second chrominance component is determined when the first chrominance component and the second chrominance component of the current picture block are filtered using a trained neural network filter. Specifically, as shown in FIG. 11A, the decoder side inputs, according to the first filtering order, for example, the filtering order in which the U component precedes the V component, the U component and the V component of the surrounding filtered area of the current picture block into the neural network filter NNLF for filtering to output a filtered value of the U component and a filtered value of the V component of the surrounding filtered area. Next, a second filtering cost 1 corresponding to the first filtering order is determined based on the filtered value of the U component and the filtered value of the V component of the surrounding filtered area in the first filtering order, and the surrounding filtered area. Similarly, as shown in FIG. 11A, the decoder side inputs, according to the second filtering order, for example, the filtering order in which the V component precedes the U component, the U component and the V component of the surrounding filtered area of the current picture block into the neural network filter NNLF for filtering to output a filtered value of the U component and a filtered value of the V component of the surrounding filtered area. Next, a second filtering cost 2 corresponding to the second filtering order is determined based on the filtered value of the U component and the filtered value of the V component of the surrounding filtered area in the second filtering order, and the surrounding filtered area. Finally, the target filtering order of the chrominance components of the current picture block is determined from the first filtering order and the second filtering order according to the second filtering costs corresponding to the first filtering order and the second filtering order.

In another example, in a training process, a chrominance training order of the neural network filter is a first training order. For example, the V component and the U component are sequentially inputted, and filtering results of the V component and the U component are correspondingly constrained using loss functions to train the neural network filter. The target filtering order of the first chrominance component and the second chrominance component is determined when the first chrominance component and the second chrominance component of the current picture block are filtered using a trained neural network filter. Specifically, as shown in FIG. 11B, the decoder side inputs, according to the first filtering order, for example, the filtering order in which the U component precedes the V component, the U component and the V component of the surrounding filtered area of the current picture block into the neural network filter NNLF for filtering to output a filtered value of the U component and a filtered value of the V component of the surrounding filtered area. Next, a second filtering cost 1 corresponding to the first filtering order is determined based on the filtered value of the U component and the filtered value of the V component of the surrounding filtered area in the first filtering order, and the surrounding filtered area. Similarly, as shown in FIG. 11B, the decoder side inputs, according to the second filtering order, for example, the filtering order in which the V component precedes the U component, the U component and the V component of the surrounding filtered area of the current picture block into the neural network filter NNLF for filtering to output a filtered value of the U component and a filtered value of the V component of the surrounding filtered area. Next, a second filtering cost 2 corresponding to the second filtering order is determined based on the filtered value of the U component and the filtered value of the V component of the surrounding filtered area in the second filtering order, and the surrounding filtered area. Finally, the target filtering order of the chrominance components of the current picture block is determined from the first filtering order and the second filtering order according to the second filtering costs corresponding to the first filtering order and the second filtering order.

It can be known from the foregoing description that a process of determining the target filtering order in this embodiment of this disclosure is irrelevant to the chrominance training order of the neural network filter, thereby improving the flexibility and accuracy of selecting the target filtering order.

The foregoing describes the process of determining the target filtering order by taking N filtering orders including the first filtering order and the second filtering order as an example. If the N filtering orders further include other filtering orders, for example, other filtering orders shown in Table 2, second filtering costs of a surrounding decoded area in other filtering orders are determined using a method the same as that for the first filtering order and the second filtering order. In this way, second filtering costs corresponding to the N filtering orders may be determined, and the target filtering order is further determined from the N filtering orders based on the second filtering costs corresponding to the N filtering orders. For example, a filtering order having a smallest second filtering cost in the N filtering orders is determined as the target filtering order.

After determining the target filtering order of the first chrominance component and the second chrominance component of the current picture block based on the foregoing operations, the decoder side performs the following operation of S103.

S103: input, based on the target filtering order, the first chrominance component and the second chrominance component of the current picture block into a neural network filter for filtering to obtain a chrominance filtering block of the current picture block. In an example, based on the determined target filtering order, the first chrominance component and the second chrominance component of the current block are input into a neural network filter to obtain a chrominance filtering block of the current block.

After determining the target filtering order of the first chrominance component and the second chrominance component of the current picture block based on the foregoing operations, the decoder side inputs the first chrominance component and the second chrominance component of the current picture block into the neural network filter for filtering according to the target filtering order to obtain a filtered picture block of the current picture block.

In an example, as shown in FIG. 12A, if the foregoing target filtering order is that the first chrominance component precedes the second chrominance component, the first chrominance component and the second chrominance component of the current picture block are spliced, and the first chrominance component precedes the second chrominance component during splicing. Next, the spliced first chrominance component and second chrominance component are inputted into the neural network filter for filtering to obtain a filtered value of the first chrominance component and a filtered value of the second chrominance component of the current picture block, where the filtered value of the first chrominance component and the filtered value of the second chrominance component of the current picture block form the chrominance filtering block of the current picture block.

In an example, as shown in FIG. 12B, if the foregoing target filtering order is that the second chrominance component precedes the first chrominance component, the first chrominance component and the second chrominance component of the current picture block are spliced, and the first chrominance component precedes the second chrominance component during splicing. Next, the spliced first chrominance component and second chrominance component are inputted into the neural network filter for filtering to obtain a filtered value of the first chrominance component and a filtered value of the second chrominance component of the current picture block, where the filtered value of the first chrominance component and the filtered value of the second chrominance component of the current picture block form the chrominance filtering block of the current picture block.

The filtering process of the current picture block in the reconstructed picture is described above. A filtering process of another to-be-filtered picture block in the reconstructed picture may refer to the foregoing filtering process of the current picture block, and finally a filtered reconstructed picture is obtained.

In some embodiments, the foregoing neural network filter is used as a loop filter. In this case, an output of the neural network filter affects video decoding. For example, the decoder side filters the reconstructed picture of the current picture using the neural network filter through the foregoing method to obtain a filtered reconstructed picture, and stores the filtered reconstructed picture in a decoding buffer as a decoded picture for subsequent picture filtering. In this embodiment of this disclosure, the accuracy of determining the filtering order is provided, thereby improving the filtering quality of the reconstructed picture. In this way, the video decoding effect may be improved when subsequent decoding is performed based on a reconstructed picture with good quality.

In some embodiments, the foregoing neural network filter is configured for post-processing, that is, filtering optimization is performed on a decoded video. In this case, the output of the neural network filter does not affect video decoding. For example, the decoder side decodes a video code stream to obtain a decoded video, and then filters at least one picture in the decoded video using the neural network filter. In this case, each of the at least one picture may be recorded as a reconstructed picture. Next, the decoder side filters the reconstructed picture using the neural network filter through the foregoing method to obtain a filtered reconstructed picture, and directly stores the filtered reconstructed picture in another place or directly outputs the filtered reconstructed picture for display, instead of buffering the filtered reconstructed picture in the decoding buffer for subsequent decoding. In this case, the picture filtering method in this embodiment of this disclosure is configured for post-processing of the decoded video.

In some embodiments, in addition to being applied to the field of video or picture decoding, the picture filtering method proposed by this embodiment of this disclosure may be further applied to conventional picture filtering. For example, for a current picture block in a to-be-filtered picture, a target filtering order of a first chrominance component and a second chrominance component of the current picture block is determined. The target filtering order is determined based on filtering costs of N filtering orders, and N is a positive integer greater than 1. Based on the target filtering order, the first chrominance component and the second chrominance component of the current picture block are inputted into the neural network filter for filtering to obtain the chrominance filtering block of the current picture block.

In the picture filtering method provided in this embodiment of this disclosure, when decoding the current picture, the decoder side first decodes the code stream of the current picture to obtain the residual value of the current picture, and determines the reconstructed picture of the current picture based on the residual value. For the to-be-filtered current picture block in the reconstructed picture, the target filtering order of the first chrominance component and the second chrominance component of the current picture block is determined. The target filtering order is determined by decoding the code stream or based on the filtering costs of the N filtering orders, and N is a positive integer greater than 1. Based on the target filtering order, the first chrominance component and the second chrominance component of the current picture block are inputted into the neural network filter for filtering to obtain the chrominance filtering block of the current picture block. That is, in the embodiments of this disclosure, the target filtering order is determined based on the filtering costs of the N filtering orders so that the accuracy of selecting the target filtering order is improved. When the first chrominance component and the second chrominance component of the current picture block are inputted into the neural network filter for filtering based on the determined target filtering order, the filtering effect may be improved, thereby improving the generalization of the neural network filter and improving the decoding performance.

The picture filtering method in this embodiment of this disclosure is described above by taking the decoder side as an example. The picture filtering method in this embodiment of this disclosure is described below by taking the coder side as an example.

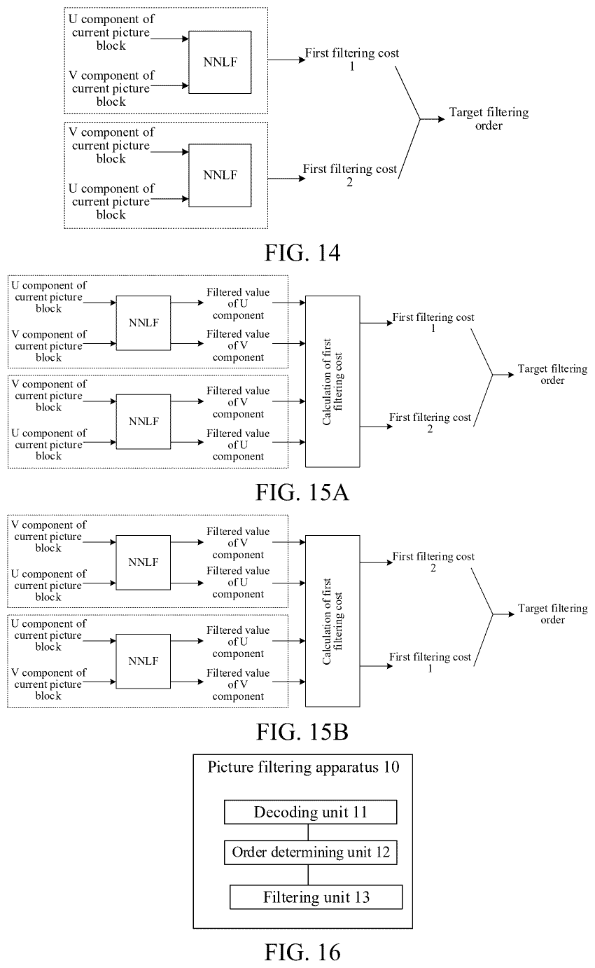

FIG. 13 is a schematic flowchart of a picture filtering method according to an embodiment of this disclosure. This embodiment of this disclosure is applied to the coder shown in FIG. 1 or FIG. 2. As shown in FIG. 13, the method provided in this embodiment of this disclosure includes the following operations.

S201: code a current picture to obtain a reconstructed picture of the current picture. In an example, a current picture is encoded and the encoded current picture is reconstructed.

In this embodiment of this disclosure, when coding the current picture, a coder side divides the current picture into coding blocks and performs block-by-block coding using the coding block as a CU. For example, for a to-be-coded current block in the current picture, a prediction value of the current block is first obtained in an inter and/or intra prediction manner. Then, a residual value of the current block is obtained based on the predicted value of the current block and the current block. The coder side transforms the residual value of the current block to obtain a transform coefficient. In one example, the coder side does not quantize the transform coefficient of the current block and directly codes the transform coefficient to obtain the code stream. In another example, the coder side quantizes the transform coefficient of the current block to obtain a quantized coefficient, and then codes the quantized coefficient to obtain the code stream.

In a coding process, as shown in FIG. 2, the coder side further performs inverse transform on the transform coefficient to obtain a residual value, and adds the residual value and the predicted value to obtain a reconstructed value of the current block. Based on the foregoing operations, reconstructed values of coding blocks in the current picture may be obtained, and these reconstructed values form the reconstructed picture of the current picture. Next, to further improve the quality of the reconstructed picture, the reconstructed picture is filtered to obtain a decoded picture of the current picture. In an example, the decoded picture may be stored in a decoding buffer for subsequent picture prediction.

In some embodiments, the picture filtering method proposed by this embodiment of this disclosure may be configured for filtering at least one frame of picture in a video. That is, the foregoing current picture is a picture in the video.

In some embodiments, the picture filtering method proposed by this embodiment of this disclosure may be configured for decoding a single picture. That is, the foregoing current picture is an independent picture, for example, a picture generated by an electronic device.

After obtaining the reconstructed picture of the current picture based on the foregoing operations, the coder side performs the following operation of S202.

S202: determine, for a to-be-filtered current picture block in the reconstructed picture, a target filtering order of a first chrominance component and a second chrominance component of the current picture block. In an example, a target filtering order, for a current block in the reconstructed current picture, is determined from a plurality of filtering orders of a first chrominance component and a second chrominance component of the current block.

The target filtering order is determined based on filtering costs of N filtering orders, and N is a positive integer greater than 1.

In this embodiment of this disclosure, to improve the quality of the reconstructed picture, the reconstructed picture is filtered. Specifically, the reconstructed picture is filtered using a neural network filter. When the reconstructed picture is filtered, the reconstructed picture is divided into at least one picture block, and each picture block is filtered separately. Processes in which the coder side filters the picture blocks in the reconstructed picture using the neural network filter are basically consistent. For ease of description, filtering the current picture block in the reconstructed picture is used as an example herein for description.

The size and shape of the foregoing current picture block are not limited in this embodiment of this disclosure.

In one possible implementation, the foregoing to-be-filtered current picture block is at least one CTU of the reconstructed picture. That is, at least one CTU of the reconstructed picture is divided into a picture block and inputted into the neural network filter for filtering.

In some examples, as shown in FIG. 8A, the current picture block is a CTU of the reconstructed picture, that is, a CTU of the reconstructed picture is used as an input picture block of the neural network filter.

In another example, as shown in FIG. 8B, the current picture block is four CTUs of the reconstructed picture, that is, the four CTUs of the reconstructed picture are used as an input picture block of the neural network filter.

In an example, a plurality of CTUs such as two CTUs or three CTUs of the reconstructed picture may further be used as an input picture block of the neural network filter. The plurality of CTUs may be a plurality of CTUs in a horizontal direction or a plurality of CTUs in a vertical direction. In some embodiments, the plurality of CTUs may be adjacent, or not adjacent, or some are adjacent, and some are not adjacent.

In another possible implementation, the foregoing to-be-filtered current picture block is a preset picture area of the reconstructed picture. That is, the coder side uses a preset picture area of the reconstructed picture as an input picture block of the neural network filter.

A specific shape and size of the preset picture area are not limited in this embodiment of this disclosure.

In an example, as shown in FIG. 8C, the preset picture area includes at least one missing number of CTUs of the reconstructed picture, that is, the at least one missing number of CTUs of the reconstructed picture is used as an input picture block of the neural network filter.

In some embodiments, the foregoing preset picture area is a fixed area. For example, during each filtering process, the to-be-filtered current picture block in the reconstructed picture is obtained according to the preset picture area, and the picture block is used as an input picture block of the neural network filter. In this case, the sizes and shapes of the picture blocks inputted into the neural network filter are the same, and the picture blocks each are a preset picture area.

In some embodiments, the preset picture area is a change value. For example, during the first filtering, a to-be-filtered picture block in the reconstructed picture is obtained according to a first preset picture area and inputted as an input picture block into the neural network filter for filtering. During the second filtering, a to-be-filtered picture block in the reconstructed picture is obtained according to a second preset picture area and inputted as an input picture block into the neural network filter for filtering, and so on. In an example of this embodiment, the coder side may divide the reconstructed picture into several to-be-filtered picture blocks. Shapes and sizes of the several to-be-filtered picture blocks may be the same or different, or may be partially the same or partially different.

Based on the foregoing operations, after determining the to-be-filtered current picture block in the reconstructed picture, the coder side filters the current picture block using the neural network filter.

The current picture block includes luminance components and chrominance components, and the chrominance component includes a U component and a V component. Since the U component and the V component in the chrominance have similar characteristics, the same neural network filter is usually used for filtering.

It can be known from the foregoing description that currently, when the chrominance components are filtered, a filtering order of the chrominance components is fixed and is usually consistent with an input order of the chrominance components during training of the neural network filter. For example, during training, the U component and the V component are inputted into the neural network filter in an order that the U component precedes the V component to train the neural network filter. In this way, in an actual filtering process, the U component and the V component are inputted into the neural network filter for filtering according to a filtering order in which the U component precedes the V component. However, when filtering is performed by keeping the filtering order of the chrominance components the same as the training order, a poor filtering effect is caused, and the generalization of the neural network filter is reduced.

To resolve the technical problem, in the embodiments of this disclosure, when the chrominance components of the current picture block are filtered, the target filtering order of the first chrominance component and the second chrominance component of the current picture block is first determined. The target filtering order is determined based on filtering costs of N filtering orders so that the accuracy of determining the target filtering order may be improved. In this way, when the chrominance components of the current picture block are filtered based on the determined target filtering order, the filtering effect of the chrominance components may be effectively improved, thereby improving the generalization of the neural network filter.

The filtering cost in this embodiment of this disclosure includes at least one of a calculation cost and a distortion cost. That is, in some embodiments, the filtering cost of the filtering order in this embodiment of this disclosure includes a calculation cost of the filtering order. For example, higher calculation time and/or calculation complexity indicates a larger calculation cost. In some embodiments, the filtering cost of the filtering order in this embodiment of this disclosure includes a distortion cost of the filtering order. For example, a higher distortion degree indicates a larger distortion cost. In some embodiments, the filtering cost of the filtering order in this embodiment of this disclosure includes the calculation cost and the distortion cost of the filtering order. For example, a larger sum of the distortion cost and the calculation cost indicates a larger filtering cost.

A specific process in which the coder side determines the target filtering order of the first chrominance component and the second chrominance component of the current picture block is described below.

In this embodiment of this disclosure, specific manners in which the coder side determines the target filtering order include, but are not limited to, the following several manners.

First manner: the coder side determines the target filtering order based on the current picture block. In this case, determining the target filtering order of the first chrominance component and the second chrominance component of the current picture block in S202 includes the following operations of S202-A1 and S202-A2.

S202-A1: input, for a j-th filtering order in the N filtering orders, the first chrominance component and the second chrominance component of the current picture block into the neural network filter for filtering according to the j-th filtering order to determine a j-th first filtering cost of the current picture block in the j-th filtering order, j being a positive integer less than or equal to N.

S202-A2: determine the target filtering order from the N filtering orders based on first filtering costs corresponding to the N filtering orders.

In the first manner, the coder side inputs the first chrominance component and the second chrominance component of the current picture block into the neural network filter for filtering according to each of the N filtering orders, determines a filtering cost corresponding to each of the N filtering orders, and records the filtering cost as the first filtering cost. In this embodiment, specific processes in which the coder side determines first filtering costs corresponding to the N filtering orders are basically the same. A j-th filtering order in the N filtering orders is used as an example for description. That is, the first chrominance component and the second chrominance component of the current picture block are inputted into the neural network filter for filtering according to the j-th filtering order to determine the j-th first filtering cost of the current picture block in the j-th filtering order.

A specific manner of determining the j-th first filtering cost of the current picture block in the j-th filtering order is not limited in this embodiment of this disclosure.

In a possible implementation, the coder side inputs the first chrominance component and the second chrominance component of the current picture block into the neural network filter for filtering according to the j-th filtering order to obtain a filtered value of the first chrominance component of the current picture block in the j-th filtering order and a filtered value of the second chrominance component in the j-th filtering order. Further, the first filtering cost corresponding to the j-th filtering order is determined based on the filtered value of the first chrominance component of the current picture block in the j-th filtering order and the filtered value of the second chrominance component in the j-th filtering order. For example, if the first filtering cost includes a calculation cost, the coder side determines a calculation cost when the first chrominance component and the second chrominance component of the current picture block are filtered through the neural network filter in the j-th filtering order, and further determines, based on the calculation cost, the first filtering cost corresponding to the j-th filtering order.

In a possible implementation, S202-B2 includes the following operations of S202-B21 and S202-B22.

S202-B21: input the first chrominance component and the second chrominance component of the current picture block into the neural network filter for filtering according to the j-th filtering order to obtain a j-th filtered picture block of the current picture block.

S202-B22: determine the j-th first filtering cost based on the j-th filtered picture block and an original picture block of the current picture block.

In this implementation, the coder side inputs the first chrominance component and the second chrominance component of the current picture block into the neural network filter for filtering according to the j-th filtering order to obtain the filtered value of the first chrominance component of the current picture block in the j-th filtering order and the filtered value of the second chrominance component in the j-th filtering order. For ease of description, the filtered value of the first chrominance component of the current picture block in the j-th filtering order and the filtered value of the second chrominance component in the j-th filtering order are recorded as the j-th filtered value of the current picture block.

Next, the first filtering cost corresponding to the j-th filtering order is determined based on the j-th filtered picture block and an original picture block of the current picture block.

For example, if the first filtering cost includes a distortion cost, the coder side determines the first filtering cost corresponding to the j-th filtering order based on the filtered value of the first chrominance component of the current picture block, a first chrominance component of the original picture block of the current picture block, the filtered value of the second chrominance component of the current picture block, and a second chrominance component of the original picture block of the current picture block in the j-th filtering order.

A specific calculation manner of the first filtering costs is not limited in this embodiment of this disclosure. For example, the foregoing first filtering cost may be RDO or an approximate cost such as SSD, STAD, or SAD.

For another example, if the first filtering cost includes the calculation cost and the distortion cost, the coder side determines a distortion cost corresponding to the j-th filtering order based on the filtered value of the first chrominance component of the current picture block, the first chrominance component of the original picture block of the current picture block, the filtered value of the second chrominance component of the current picture block, and the second chrominance component of the original picture block of the current picture block in the j-th filtering order. Meanwhile, a calculation cost when the first chrominance component and the second chrominance component of the current picture block are filtered through the neural network filter in the j-th filtering order is determined. In this way, the first filtering cost corresponding to the j-th filtering order is determined according to the distortion cost and the calculation cost corresponding to the j-th filtering order. For example, a sum or a weighted sum of the distortion cost and the calculation cost corresponding to the j-th filtering order is determined as the first filtering cost corresponding to the j-th filtering order.

Based on the foregoing operations, the coder side may determine first filtering costs of the current picture block in the N filtering orders. Further, the target filtering order is determined from the N filtering orders based on the first filtering costs corresponding to the N filtering orders.

A specific manner in which the coder side determines the target filtering order from the N filtering orders based on the first filtering costs corresponding to the N filtering orders is not limited in this embodiment of this disclosure.

For example, a filtering order having a smallest first filtering cost in the N filtering orders is determined as the target filtering order.

For another example, any one of the N filtering orders having a first filtering cost less than a preset value is determined as the target filtering order.

Specific types of the foregoing N filtering orders are not limited in this embodiment of this disclosure.

In an example, the N filtering orders are shown in Table 2.

In some embodiments, the N filtering orders include a first filtering order and a second filtering order. The first filtering order is that the first chrominance component precedes the second chrominance component in inputs of the neural network filter. The second filtering order is that the second chrominance component precedes the first chrominance component in the inputs of the neural network filter.

In this case, as shown in FIG. 14, the coder side inputs, according to the first filtering order, the first chrominance component (for example, the U component) and the second chrominance component (for example, the V component) of the current picture block into the neural network filter for filtering to determine a first filtering cost 1 corresponding to the first filtering order. Meanwhile, the coder side inputs, according to the second filtering order, the first chrominance component and the second chrominance component of the current picture block into the neural network filter for filtering to determine a first filtering cost 2 corresponding to the first filtering order. Finally, the target filtering order is selected from the first filtering order and the second filtering order according to the first filtering cost 1 corresponding to the first filtering order and the first filtering cost 2 corresponding to the second filtering order. For example, a filtering order having the smallest first filtering cost in the first filtering order and the second filtering order is determined as the target filtering order.

It can be known from the foregoing description that, in this embodiment of this disclosure, when the target filtering order of the chrominance components of the current picture block is determined, a training order of the chrominance components of the neural network filter is not considered. That is, regardless of the training order of the chrominance components of the neural network filter, the coder side determines the target filtering order of the chrominance components of the current chrominance block according to the foregoing operations.

A training manner of the neural network filter and related training parameters are not limited in this embodiment of this disclosure.

In some embodiments, the neural network filter is obtained by training with at least one CTU as a training unit. That is, at least one CTU of a training picture is divided into a training unit and inputted into the neural network filter to train the neural network filter.

In some embodiments, the neural network filter is obtained by training with the preset picture area as the training unit. That is, the preset picture area of the training picture is divided into a training unit and inputted into the neural network filter to train the neural network filter. Related descriptions of the foregoing preset picture area may refer to related descriptions of the foregoing preset picture area, and details are not described herein again.

In some embodiments, a training order of chrominance components of the neural network filter is any one of N training orders. In some embodiments, the foregoing N training orders and N filtering orders may be the same or different, or may be partially the same or partially different.

In some embodiments, the foregoing N training orders include a first training order and a second training order. The first training order is that the first chrominance component precedes the second chrominance component in the inputs of the neural network filter, and the second training order is that the second chrominance component precedes the first chrominance component in the inputs of the neural network filter.

In an example, in a training process, a chrominance training order of the neural network filter is a first training order. For example, the U component and the V component are sequentially inputted, and filtering results of the U component and the V component are correspondingly constrained using loss functions to train the neural network filter. The target filtering order of the first chrominance component and the second chrominance component is determined when the first chrominance component and the second chrominance component of the current picture block are filtered using a trained neural network filter. Specifically, as shown in FIG. 15A, the coder side inputs, according to the first filtering order, for example, the filtering order in which the U component precedes the V component, the U component and the V component of the current picture block into the neural network filter NNLF for filtering to output a filtered value of the U component and a filtered value of the V component of the current picture block. Next, a first filtering cost 1 corresponding to the first filtering order is determined based on the filtered value of the U component and the filtered value of the V component of the current picture block in the first filtering order, and the original picture block of the current picture block. Similarly, as shown in FIG. 15A, the coder side inputs, according to the second filtering order, for example, the filtering order in which the V component precedes the U component, the U component and the V component of the current picture block into the neural network filter NNLF for filtering to output a filtered value of the U component and a filtered value of the V component of the current picture block. Next, a first filtering cost 2 corresponding to the second filtering order is determined based on the filtered value of the U component and the filtered value of the V component of the current picture block in the second filtering order, and the original picture block of the current picture block. Finally, the target filtering order of the chrominance components of the current picture block is determined from the first filtering order and the second filtering order according to the first filtering costs corresponding to the first filtering order and the second filtering order.

In another example, in a training process, a chrominance training order of the neural network filter is a first training order. For example, the V component and the U component are sequentially inputted, and filtering results of the V component and the U component are correspondingly constrained using loss functions to train the neural network filter. The target filtering order of the first chrominance component and the second chrominance component is determined when the first chrominance component and the second chrominance component of the current picture block are filtered using a trained neural network filter. Specifically, as shown in FIG. 15B, the coder side inputs, according to the first filtering order, for example, the filtering order in which the U component precedes the V component, the U component and the V component of the current picture block into the neural network filter NNLF for filtering to output a filtered value of the U component and a filtered value of the V component of the current picture block. Next, a first filtering cost 1 corresponding to the first filtering order is determined based on the filtered value of the U component and the filtered value of the V component of the current picture block in the first filtering order, and the original picture block of the current picture block. Similarly, as shown in FIG. 15B, the coder side inputs, according to the second filtering order, for example, the filtering order in which the V component precedes the U component, the U component and the V component of the current picture block into the neural network filter NNLF for filtering to output a filtered value of the U component and a filtered value of the V component of the current picture block. Next, a first filtering cost 2 corresponding to the second filtering order is determined based on the filtered value of the U component and the filtered value of the V component of the current picture block in the second filtering order, and the original picture block of the current picture block. Finally, the target filtering order of the chrominance components of the current picture block is determined from the first filtering order and the second filtering order according to the first filtering costs corresponding to the first filtering order and the second filtering order.

It can be known from the foregoing description that a process of determining the target filtering order in this embodiment of this disclosure is irrelevant to the chrominance training order of the neural network filter, thereby improving the flexibility and accuracy of selecting the target filtering order.

The foregoing describes the process of determining the target filtering order by taking N filtering orders including the first filtering order and the second filtering order as an example. If the N filtering orders further include other filtering orders, for example, other filtering orders shown in Table 2, first filtering costs of a surrounding coded area in other filtering orders are determined using a method the same as that for the first filtering order and the second filtering order. In this way, first filtering costs corresponding to the N filtering orders may be determined, and the target filtering order is further determined from the N filtering orders based on the first filtering costs corresponding to the N filtering orders.

In some embodiments, after determining the target filtering order based on the foregoing operations, the coder side writes first information into the code stream. The first information indicates the target filtering order. In this way, the decoder side obtains the first information by decoding the code stream, and further obtains the target filtering order based on the first information.

A specific expression form of the first information is not limited in this embodiment of this disclosure, as long as it is any syntax field that may indicate the target filtering order.

In some embodiments, the foregoing first information includes a first flag, and the target filtering order is indicated using different values of the first flag.

Illustratively, a correspondence between the value of the first flag and the filtering order of the chrominance components is shown in Table 1.

In the first manner, the coder side may determine the value of the first flag corresponding to the target filtering order based on Table 1, set the value of the first flag to this value, and then write the first flag into the code stream. In this way, the decoder side obtains the first flag by decoding the code stream, and further obtains the target filtering order of the first chrominance component and the second chrominance component of the current picture block by looking up Table 1 according to the value of the first flag.

In addition to determining the target filtering order using the method in the foregoing first manner, the coder side may further determine the target filtering order using a method in the following second manner.

Second manner: the coder side automatically determines the target filtering order. In this case, determining the target filtering order of the first chrominance component and the second chrominance component of the current picture block in S202 includes the following operations of S202-B1 to S202-B3.

S202-B1: determine a surrounding filtered area of the current picture block.

S202-B2: input, for an i-th filtering order in the N filtering orders, a first chrominance component and a second chrominance component of the surrounding filtered area into the neural network filter for filtering according to the i-th filtering order to determine an i-th second filtering cost of the surrounding filtered area in the i-th filtering order, i being a positive integer less than or equal to N.

S202-B3: determine the target filtering order from the N filtering orders based on second filtering costs corresponding to the N filtering orders.

In the second manner, the coder side determines the target filtering order from the N filtering orders based on a surrounding filtered area of the current picture block.

The size and shape of the surrounding filtered area of the current picture block are not limited in this embodiment of this disclosure.

In some embodiments, the surrounding filtered area of the current picture block is a filtered area that is around the current picture block and adjacent to the current picture block.

In some embodiments, as shown in FIG. 9, a surrounding filtered area of the current picture block includes an upper filtered area and a left filtered area of the current picture block.

In some embodiments, the surrounding filtered area of the current picture block includes a template area of the current picture.

After determining the surrounding filtered area of the current picture block in the current picture, the coder side performs the foregoing operation of S202-B2, inputs the first chrominance component and the second chrominance component of the surrounding filtered area into the neural network filter for filtering according to each of the N filtering orders, determines a filtering cost corresponding to each of the N filtering orders, and records the filtering cost as a second filtering cost. In this embodiment, specific processes in which the coder side determines second filtering costs corresponding to the N filtering orders are basically the same. An i-th filtering order in the N filtering orders is used as an example for description. That is, the first chrominance component and the second chrominance component of the surrounding filtered area are inputted into the neural network filter for filtering according to the i-th filtering order to determine the i-th second filtering cost of the surrounding filtered area in the i-th filtering order.

A specific manner of determining the i-th second filtering cost of the surrounding filtered area in the i-th filtering order is not limited in this embodiment of this disclosure.

In a possible implementation, the coder side inputs the first chrominance component and the second chrominance component of the surrounding filtered area into the neural network filter for filtering according to the i-th filtering order to obtain a filtered value of the first chrominance component of the surrounding filtered area in the i-th filtering order and a filtered value of the second chrominance component in the i-th filtering order. Further, the second filtering cost corresponding to the i-th filtering order is determined based on the filtered value of the first chrominance component of the surrounding filtered area in the i-th filtering order and the filtered value of the second chrominance component in the i-th filtering order. For example, if the second filtering cost includes a calculation cost, the coder side determines a calculation cost when the first chrominance component and the second chrominance component of the surrounding filtered area are filtered through the neural network filter in the i-th filtering order, and further determines, based on the calculation cost, the second filtering cost corresponding to the i-th filtering order.

In a possible implementation, S202-B2 includes the following operations of S202-B21 and S202-B22.

S202-B21: input the first chrominance component and the second chrominance component of the surrounding filtered area into the neural network filter for filtering according to the i-th filtering order to obtain an i-th filtered value of the surrounding filtered area.

S202-B22: determine the i-th second filtering cost based on the i-th filtered value and the surrounding filtered area.

In this implementation, the coder side inputs the first chrominance component and the second chrominance component of the surrounding filtered area into the neural network filter for filtering according to the i-th filtering order to obtain the filtered value of the first chrominance component of the surrounding filtered area in the i-th filtering order and the filtered value of the second chrominance component in the i-th filtering order. For ease of description, the filtered value of the first chrominance component of the surrounding filtered area in the i-th filtering order and the filtered value of the second chrominance component in the i-th filtering order are recorded as the i-th filtered value of the surrounding filtered area.

Next, the second filtering cost corresponding to the i-th filtering order is determined based on the i-th filtered value and the surrounding filtered area.

For example, if the second filtering cost includes a distortion cost, the coder side determines the second filtering cost corresponding to the i-th filtering order based on the filtered value of the first chrominance component of the surrounding filtered area, the first chrominance component of the surrounding filtered area, the filtered value of the second chrominance component of the surrounding filtered area, and the second chrominance component of the surrounding filtered area in the i-th filtering order.

A specific calculation manner of the second filtering costs is not limited in this embodiment of this disclosure. For example, the foregoing second filtering cost may be RDO or an approximate cost such as SSD, STAD, or SAD.

For another example, if the second filtering cost includes the calculation cost and the distortion cost, the coder side determines the distortion cost corresponding to the i-th filtering order based on the filtered value of the first chrominance component of the surrounding filtered area, the first chrominance component of the surrounding filtered area, the filtered value of the second chrominance component of the surrounding filtered area, and the second chrominance component of the surrounding filtered area in the i-th filtering order. Meanwhile, a calculation cost when the first chrominance component and the second chrominance component of the surrounding filtered area are filtered through the neural network filter in the i-th filtering order is determined. In this way, the second filtering cost corresponding to the i-th filtering order is determined according to the distortion cost and the calculation cost corresponding to the i-th filtering order. For example, a sum or a weighted sum of the distortion cost and the calculation cost corresponding to the i-th filtering order is determined as the second filtering cost corresponding to the i-th filtering order.

Based on the foregoing operations, the coder side may determine second filtering costs of the surrounding filtered area of the current picture block in the N filtering orders. Further, the target filtering order is determined from the N filtering orders based on the second filtering costs corresponding to the N filtering orders.

A specific manner in which the coder side determines the target filtering order from the N filtering orders based on the second filtering costs corresponding to the N filtering orders is not limited in this embodiment of this disclosure.

For example, a filtering order having a smallest second filtering cost in the N filtering orders is determined as the target filtering order.

For another example, any one of the N filtering orders having a second filtering cost less than a preset value is determined as the target filtering order.

After determining the target filtering order of the first chrominance component and the second chrominance component of the current picture block based on the foregoing operations, the coder side performs the following operation of S203.

S203: input, based on the target filtering order, the first chrominance component and the second chrominance component of the current picture block into a neural network filter for filtering to obtain a chrominance filtering block of the current picture block. In an example, based on the determined target filtering order, the first chrominance component and the second chrominance component of the current block are input into a neural network filter to obtain a chrominance filtering block of the current block.

After determining the target filtering order of the first chrominance component and the second chrominance component of the current picture block based on the foregoing operations, the coder side inputs the first chrominance component and the second chrominance component of the current picture block into the neural network filter for filtering according to the target filtering order to obtain a filtered picture block of the current picture block.

In an example, as shown in FIG. 12A, if the foregoing target filtering order is that the first chrominance component precedes the second chrominance component, the first chrominance component and the second chrominance component of the current picture block are spliced, and the first chrominance component precedes the second chrominance component during splicing. Next, the spliced first chrominance component and second chrominance component are inputted into the neural network filter for filtering to obtain a filtered value of the first chrominance component and a filtered value of the second chrominance component of the current picture block, where the filtered value of the first chrominance component and the filtered value of the second chrominance component of the current picture block form the chrominance filtering block of the current picture block.

In an example, as shown in FIG. 12B, if the foregoing target filtering order is that the second chrominance component precedes the first chrominance component, the first chrominance component and the second chrominance component of the current picture block are spliced, and the first chrominance component precedes the second chrominance component during splicing. Next, the spliced first chrominance component and second chrominance component are inputted into the neural network filter for filtering to obtain a filtered value of the first chrominance component and a filtered value of the second chrominance component of the current picture block, where the filtered value of the first chrominance component and the filtered value of the second chrominance component of the current picture block form the chrominance filtering block of the current picture block.

The filtering process of the current picture block in the reconstructed picture is described above. A filtering process of another to-be-filtered picture block in the reconstructed picture may refer to the foregoing filtering process of the current picture block, and finally a filtered reconstructed picture is obtained.

In some embodiments, the foregoing neural network filter is used as a loop filter. In this case, an output of the neural network filter affects video coding. For example, the coder side filters the reconstructed picture of the current picture using the neural network filter through the foregoing method to obtain a filtered reconstructed picture, and stores the filtered reconstructed picture in a coding buffer as a coded picture for subsequent picture filtering. In this embodiment of this disclosure, the accuracy of determining the filtering order is provided, thereby improving the filtering quality of the reconstructed picture. In this way, the video coding effect may be improved when subsequent coding is performed based on a reconstructed picture with good quality.

In some embodiments, the foregoing neural network filter is configured for post-processing, that is, filtering optimization is performed on a coded video. In this case, the output of the neural network filter does not affect video coding.

In some embodiments, in addition to being applied to the field of video or picture coding, the picture filtering method proposed by this embodiment of this disclosure may be further applied to conventional picture filtering. For example, for a current picture block in a to-be-filtered picture, a target filtering order of a first chrominance component and a second chrominance component of the current picture block is determined. The target filtering order is determined based on filtering costs of N filtering orders, and N is a positive integer greater than 1. Based on the target filtering order, the first chrominance component and the second chrominance component of the current picture block are inputted into the neural network filter for filtering to obtain the chrominance filtering block of the current picture block.

In the picture filtering method provided in this embodiment of this disclosure, when coding the current picture, the coder side first codes the current picture to obtain the reconstructed picture of the current picture. For the to-be-filtered current picture block in the reconstructed picture, the target filtering order of the first chrominance component and the second chrominance component of the current picture block is determined. The target filtering order is determined based on the filtering costs of the N filtering orders, and N is a positive integer greater than 1. Based on the target filtering order, the first chrominance component and the second chrominance component of the current picture block are inputted into the neural network filter for filtering to obtain the chrominance filtering block of the current picture block. That is, in the embodiments of this disclosure, the target filtering order is determined based on the filtering costs of the N filtering orders so that the accuracy of selecting the target filtering order is improved. When the first chrominance component and the second chrominance component of the current picture block are inputted into the neural network filter for filtering based on the determined target filtering order, the filtering effect may be improved, thereby improving the generalization of the neural network filter and improving the coding performance.

Implementations of this disclosure are described above with reference to the accompanying drawings. However, this disclosure is not limited to the specific details in the foregoing implementations, modifications may be made to the technical solutions of this disclosure within a range of the technical concept of this disclosure, and these modifications fall within the protection scope of this disclosure. For example, the specific technical features described in the foregoing specific implementations may be combined in any proper manner in a case without conflict. To avoid unnecessary repetitions, the various possible combinations will not be described separately herein. For another example, different implementations of this disclosure may further be combined in various manners without departing from the idea of this disclosure, and these combinations shall still be regarded as content disclosed in this disclosure.

In the method embodiments of this disclosure, sequence numbers of the foregoing processes do not indicate execution orders. The execution orders of the processes are to be determined according to functions and internal logic of the processes and are not to be construed as any limitation to the implementation processes of the embodiments of this disclosure.

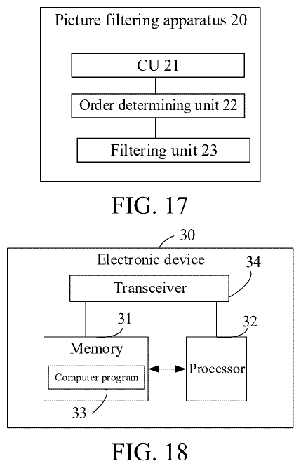

The method embodiments of this disclosure are described in detail above with reference to FIG. 7 to FIG. 15B, and apparatus embodiments of this disclosure are described in detail below with reference to FIG. 16 to FIG. 17.

FIG. 16 is a schematic block diagram of a picture filtering apparatus according to an embodiment of this disclosure.

As shown in FIG. 10, the picture filtering apparatus 10 may include a decoding unit 11, an order determining unit 12, and a filtering unit 13.

The decoding unit 11 is configured to decode a code stream of a current picture to obtain a residual value of the current picture, and determine a reconstructed picture of the current picture based on the residual value.

The order determining unit 12 is configured to determine, for a to-be-filtered current picture block in the reconstructed picture, a target filtering order of a first chrominance component and a second chrominance component of the current picture block, the target filtering order being determined by decoding the code stream or based on filtering costs of N filtering orders, and N being a positive integer greater than 1.

The filtering unit 13 is configured to input, based on the target filtering order, the first chrominance component and the second chrominance component of the current picture block into a neural network filter for filtering to obtain a chrominance filtering block of the current picture block.

In some embodiments, the order determining unit 12 is specifically configured to decode the code stream to obtain first information, the first information being configured for indicating the target filtering order; and obtain the target filtering order based on the first information.

In some embodiments, the filtering cost includes a first filtering cost, the target filtering order is determined based on a first filtering cost of each of the N filtering orders, and the first filtering cost of the filtering order is a filtering cost determined when the first chrominance component and the second chrominance component of the current picture block are inputted into the neural network filter for filtering according to the filtering order.

In some embodiments, the target filtering order is a filtering order having a smallest first filtering cost in the N filtering orders.

In some embodiments, the filtering cost includes a second filtering cost, and the order determining unit 12 is specifically configured to determine a surrounding filtered area of the current picture block; input, for an i-th filtering order in the N filtering orders, a first chrominance component and a second chrominance component of the surrounding filtered area into the neural network filter for filtering according to the i-th filtering order to determine an i-th second filtering cost of the surrounding filtered area in the i-th filtering order, i being a positive integer less than or equal to N; and determine the target filtering order from the N filtering orders based on second filtering costs corresponding to the N filtering orders.

In some embodiments, the order determining unit 12 is specifically configured to input the first chrominance component and the second chrominance component of the surrounding filtered area into the neural network filter for filtering according to the i-th filtering order to obtain an i-th filtered value of the surrounding filtered area; and determine the i-th second filtering cost based on the i-th filtered value and the surrounding filtered area.

In some embodiments, the order determining unit 12 is specifically configured to determine a filtering order having a smallest second filtering cost in the N filtering orders as the target filtering order.

In some embodiments, the N filtering orders include a first filtering order and a second filtering order; the first filtering order is that the first chrominance component precedes the second chrominance component in inputs of the neural network filter, and the second filtering order is that the second chrominance component precedes the first chrominance component in the inputs of the neural network filter.

In some embodiments, the current picture block is at least one CTU of the reconstructed picture, or the current picture block is a preset picture area of the reconstructed picture.

In some embodiments, the neural network filter is obtained by training with the at least one CTU as a training unit, or the neural network filter is obtained by training with the preset picture area as the training unit.

In some embodiments, a training order of chrominance components of the neural network filter is any one of N training orders.

In some embodiments, the N training orders include a first training order and a second training order; the first training order is that the first chrominance component precedes the second chrominance component in the inputs of the neural network filter, and the second training order is that the second chrominance component precedes the first chrominance component in the inputs of the neural network filter.

The apparatus embodiments and the method embodiments may correspond to each other, and similar descriptions may refer to the method embodiments. To avoid duplication, details are not described herein again. Specifically, the apparatus shown in FIG. 16 may perform the method embodiment shown in FIG. 7, and the foregoing and other operations and/or functions of the modules in the apparatus are separately used for implementing the method embodiment corresponding to the decoder. For brevity, details are not described herein again.

FIG. 17 is a schematic block diagram of a picture filtering apparatus according to an embodiment of this disclosure.

As shown in FIG. 17, the picture filtering apparatus 20 may include a CU 21, an order determining unit 22, and a filtering unit 23.

The CU 21 is configured to code a current picture to obtain a reconstructed picture of the current picture.

The order determining unit 22 is configured to determine, for a to-be-filtered current picture block in the reconstructed picture, a target filtering order of a first chrominance component and a second chrominance component of the current picture block, the target filtering order being determined based on filtering costs of N filtering orders, and N being a positive integer greater than 1.

The filtering unit 23 is configured to input, based on the target filtering order, the first chrominance component and the second chrominance component of the current picture block into a neural network filter for filtering to obtain a filtered picture block of the current picture block.

In some embodiments, the order determining unit 22 is specifically configured to input, for a j-th filtering order in the N filtering orders, the first chrominance component and the second chrominance component of the current picture block into the neural network filter for filtering according to the j-th filtering order to determine a j-th first filtering cost of the current picture block in the j-th filtering order, j being a positive integer less than or equal to N; and determine the target filtering order from the N filtering orders based on first filtering costs corresponding to the N filtering orders.

In some embodiments, the order determining unit 22 is specifically configured to input the first chrominance component and the second chrominance component of the current picture block into the neural network filter for filtering according to the j-th filtering order to obtain a j-th filtered picture block of the current picture block; and determine the j-th first filtering cost based on the j-th filtered picture block and an original picture block of the current picture block.

In some embodiments, the order determining unit 22 is specifically configured to determine a filtering order having a smallest first filtering cost in the N filtering orders as the target filtering order.

In some embodiments, the CU 21 is further configured to write first information into a code stream, the first information being configured for indicating the target filtering order.

In some embodiments, the order determining unit 22 is specifically configured to determine a surrounding filtered area of the current picture block; input, for an i-th filtering order in the N filtering orders, a first chrominance component and a second chrominance component of the surrounding filtered area into the neural network filter for filtering according to the i-th filtering order to determine an i-th second filtering cost of the surrounding filtered area in the i-th filtering order, i being a positive integer less than or equal to N; and determine the target filtering order from the N filtering orders based on second filtering costs corresponding to the N filtering orders.

In some embodiments, the order determining unit 22 is specifically configured to input the first chrominance component and the second chrominance component of the surrounding filtered area into the neural network filter for filtering according to the i-th filtering order to obtain an i-th filtered value of the surrounding filtered area; and determine the i-th second filtering cost based on the i-th filtered value and the surrounding filtered area.

In some embodiments, the order determining unit 22 is specifically configured to determine a filtering order having a smallest second filtering cost in the N filtering orders as the target filtering order.

In some embodiments, the N filtering orders include a first filtering order and a second filtering order; the first filtering order is that the first chrominance component precedes the second chrominance component in inputs of the neural network filter, and the second filtering order is that the second chrominance component precedes the first chrominance component in the inputs of the neural network filter.

In some embodiments, the current picture block is at least one CTU of the reconstructed picture, or the current picture block is a preset picture area of the reconstructed picture.

In some embodiments, the neural network filter is obtained by training with the at least one CTU as a training unit, or the neural network filter is obtained by training with the preset picture area as the training unit.

In some embodiments, a training order of chrominance components of the neural network filter is any one of N training orders.

In some embodiments, the N training orders include a first training order and a second training order; the first training order is that the first chrominance component precedes the second chrominance component in the inputs of the neural network filter, and the second training order is that the second chrominance component precedes the first chrominance component in the inputs of the neural network filter.

The apparatus embodiments and the method embodiments may correspond to each other, and similar descriptions may refer to the method embodiments. To avoid duplication, details are not described herein again. Specifically, the apparatus shown in FIG. 17 may perform the foregoing method embodiment, and the foregoing and other operations and/or functions of the modules in the apparatus are separately used for implementing the method embodiment corresponding to the coder. For brevity, details are not described herein again.

The apparatus in this embodiment of this disclosure is described above with reference to the accompanying drawings from the perspective of functional modules. The functional module may be implemented in a hardware form, by instructions in a software form, or by a combination of hardware and software modules. Specifically, the operations of the method embodiments in the embodiments of this disclosure may be accomplished by integrated logic circuits of hardware in the processor and/or instructions in a software form, and the operations of the methods disclosed in conjunction with the embodiments of this disclosure may be performed directly by a hardware decoding processor, or by a combination of hardware and software modules in the decoding processor. In some embodiments, the software module may be stored in a random access memory (RAM), a flash memory, a read-only memory (ROM), a programmable ROM (PROM), an electrically erasable programmable memory, a register, and other mature storage media in the art. The storage medium is located in the memory. The processor reads information in the memory and completes the operations in the foregoing method embodiments in combination with hardware thereof.

FIG. 18 is a schematic block diagram of an electronic device according to an embodiment of this disclosure. The electronic device in FIG. 18 may be the foregoing coder or decoder.

As shown in FIG. 18, an electronic device 30 may include a memory 31 and processing circuitry, such as a processor 32. The memory 31 is configured to store a computer program 33 and transmit the computer program 33 to the processor 32. In other words, the processor 32 may invoke and run the computer program 33 from the memory 31 to implement the method in this embodiment of this disclosure.

For example, the processor 32 may be configured to perform operations in the foregoing method 200 according to instructions in the computer program 33.

In some embodiments of this disclosure, the processor 32 may include, but is not limited to a general purpose processor, a digital signal processor (DSP), an application specific integrated circuit (ASIC), a field programmable gate array (FPGA) or another programmable logic device, a discrete gate or transistor logic device, or a discrete hardware component.

In some embodiments of this disclosure, the memory 31 includes, but is not limited to a volatile memory and/or a non-volatile memory. The non-volatile memory may be a ROM, a PROM, an erasable PROM (EPROM), an electrically EPROM (EEPROM), or a flash memory. The volatile memory may be a RAM serving as an external cache. Through illustrative but not limited description, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM).

In some embodiments of this disclosure, the computer program 33 may be divided into one or more modules. The one or more modules are stored in the memory 31 and executed by the processor 32 to complete the picture filtering method provided in this disclosure. The one or more modules may be a series of computer program instruction sections that can implement specific functions, and the instruction sections are configured for describing an execution process of the computer program 33 in the electronic device 900.

As shown in FIG. 18, the electronic device 30 may further include a transceiver 34. The transceiver 34 may be connected to the processor 32 or the memory 31.

The processor 32 may control the transceiver 34 to communicate with another device. Specifically, the transceiver 34 may transmit information or data to another device, or receive information or data transmitted by another device. The transceiver 34 may include a transmitter and a receiver. The transceiver 34 may further include an antenna, and there may be one or more antennas.

Various components of the electronic device 30 are connected through a bus system. In addition to a data bus, the bus system further includes a power bus, a control bus, and a state signal bus.

According to one aspect of the embodiments of this disclosure, a computer storage medium such as a non-transitory computer-readable storage medium is provided, having a computer program stored therein. The computer program, when executed by a computer, causes the computer to perform the method in the foregoing method embodiments. Alternatively, the embodiments of this disclosure further provide a computer program product containing instructions, and the instructions, when executed by a computer, cause the computer to perform the method in the foregoing method embodiments.

According to another aspect of the embodiments of this disclosure, a computer program product or a computer program is provided, including computer instructions. The computer instructions are stored in a computer-readable storage medium. A processor of a computer device reads the computer instructions from the computer-readable storage medium, and the processor executes the computer instructions to cause the computer device to perform the method in the foregoing method embodiments.

In other words, when implemented using software, the entire or part of the implementation may be in the form of the computer program product. The computer program product includes one or more computer instructions. When the computer program instructions are loaded and executed on a computer, all or some of the procedures or functions according to the embodiments of this disclosure are generated. The computer may be a general purpose computer, a special-purpose computer, a computer network, or another programmable apparatus. The computer instructions may be stored in the computer-readable storage medium or transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium that can be accessed by a computer, or a data storage device such as a server or a data center integrated by one or more available media. The available medium may be a magnetic medium (for example, a floppy disk, a hard disk, or a magnetic tape), an optical medium (for example, a DVD), a semiconductor medium (for example, a solid state disk (SSD)), or the like.

A person skilled in the art may recognize that the examples of modules and algorithm operations described with reference to the embodiments disclosed in this specification can be implemented by electronic hardware, or a combination of computer software and electronic hardware. Whether the functions are executed in a mode of hardware or software depends on particular applications and design constraint conditions of the technical solutions. For each particular application, a person skilled in the art may use different methods to achieve the described function, but this implementation shall not be considered outside the scope of this disclosure.

In the several embodiments provided in this disclosure, the disclosed system, apparatus, and method may be implemented in other manners. For example, the foregoing apparatus embodiments are merely illustrative. For example, the division of modules is merely logical function division and may be other division in actual implementations. For example, a plurality of modules or components may be combined or integrated into another system, or some features may be ignored or not performed. In addition, the displayed or discussed mutual couplings, direct couplings, or communication connections may be indirect couplings or communication connections through some interfaces, apparatuses, or modules, and may be electrical, mechanical, or otherwise.

The modules described as separate components may or may not be physically separated, and the assemblies displayed as modules may or may not be physical modules, i.e., may be located in one place or may be distributed over a plurality of network units. Some or all of the modules may be selected according to actual needs to achieve the solutions of the embodiments. For example, functional modules in the embodiments of this disclosure may be integrated in one processing module, or each module may physically exist separately, or two or more modules may be integrated in one module.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely examples of implementations of this disclosure, and are not intended to limit the protection scope of this disclosure. Any variation or replacement readily thought of by a person skilled in the art within the technical scope disclosed in this disclosure shall fall within the protection scope of this disclosure.

What is claimed is:

1. A picture filtering method of a decoder, the method comprising:
reconstructing a current picture that is encoded in a coded bitstream;
determining, for a current block in the reconstructed current picture, a target filtering order from a plurality of filtering orders of a first chrominance component and a second chrominance component of the current block; and
inputting, based on the determined target filtering order, the first chrominance component and the second chrominance component of the current block into a neural network filter to obtain a chrominance filtering block of the current block.

2. The method according to claim 1, wherein the determining the target filtering order comprises:
obtaining order information from the coded bitstream, the order information indicating the target filtering order; and
determining the target filtering order based on the order information.

3. The method according to claim 2, wherein the determining the target filtering order comprises:
determining the target filtering order based on filtering costs of the plurality of filtering orders.

4. The method according to claim 3, wherein
the filtering costs include first filtering costs;
the target filtering order is determined based on a first filtering cost of each of the plurality of filtering orders, the first filtering cost of the respective filtering order being determined based on the first chrominance component and the second chrominance component of the current block being inputted into the neural network filter in the respective filtering order; and
the target filtering order has a smallest first filtering cost in the plurality of filtering orders.

5. The method according to claim 3, wherein
the filtering costs includes second filtering costs; and
the determining the target filtering order comprises:
determining a neighboring filtered area of the current block;
inputting, for an i-th filtering order in the plurality of filtering orders, a first chrominance component and a second chrominance component of the neighboring filtered area into the neural network filter according to the i-th filtering order to determine an i-th second filtering cost of the neighboring filtered area in the i-th filtering order, i being a positive integer less than or equal to a number N of the plurality of filtering orders; and
determining the target filtering order from the plurality of filtering orders based on the second filtering costs corresponding to the plurality of filtering orders.

6. The method according to claim 5, wherein the inputting the first chrominance component and the second chrominance component of the neighboring filtered area comprises:
inputting the first chrominance component and the second chrominance component of the neighboring filtered area into the neural network filter according to the i-th filtering order to obtain an i-th filtered value of the neighboring filtered area; and
determining the i-th second filtering cost based on the i-th filtered value and the neighboring filtered area.

7. The method according to claim 5, wherein the determining the target filtering order comprises:
determining the filtering order having a smallest second filtering cost in the plurality of filtering orders as the target filtering order.

8. The method according to claim 1, wherein
the plurality filtering orders include a first filtering order and a second filtering order;
the first filtering order is that the first chrominance component is input before the second chrominance component into the neural network filter; and
the second filtering order is that the second chrominance component is input before the first chrominance component into the neural network filter.

9. The method according to claim 1, wherein the current block is at least one coding tree unit (CTU) of the reconstructed current picture or a preset picture area of the reconstructed current picture.

10. The method according to claim 1, wherein the neural network filter is trained with at least one CTU as a training unit or a preset picture area as the training unit.

11. The method according to claim 1, wherein the neural network filter is trained based on a plurality of training orders.

12. The method according to claim 11, wherein
the plurality of training orders includes a first training order and a second training order;
the first training order is that the first chrominance component is input before the second chrominance component into the neural network filter; and
the second training order is that the second chrominance component is input before the first chrominance component into the neural network filter.

13. A picture filtering method of an encoder, the method comprising:
encoding a current picture;
reconstructing the encoded current picture;
determining, for a current block in the reconstructed current picture, a target filtering order from a plurality of filtering orders of a first chrominance component and a second chrominance component of the current block; and
inputting, based on the determined target filtering order, the first chrominance component and the second chrominance component of the current block into a neural network filter to obtain a chrominance filtering block of the current block.

14. The method according to claim 13, wherein the determining the target filtering order comprises:
determining the target filtering order based on filtering costs of the plurality of filtering orders.

15. The method according to claim 13, wherein the determining the target filtering order comprises:
inputting, for a j-th filtering order in the plurality of filtering orders, the first chrominance component and the second chrominance component of the current picture block into the neural network filter according to the j-th filtering order to determine a j-th first filtering cost of the current picture block in the j-th filtering order, j being a positive integer less than or equal to a number N of the plurality of filtering orders; and
determining the target filtering order from the plurality of filtering orders based on first filtering costs corresponding to the plurality of filtering orders.

16. The method according to claim 15, wherein
the inputting the first chrominance component and the second chrominance component comprises:
inputting the first chrominance component and the second chrominance component of the current block into the neural network filter according to the j-th filtering order to obtain a j-th chrominance filtering block of the current block; and
determining the j-th first filtering cost based on the j-th chrominance filtering block and an original block of the current block; and
the determining the target filtering order from the plurality of filtering orders based on the first filtering costs comprises:
determining the filtering order having a smallest first filtering cost in the plurality of filtering orders as the target filtering order.

17. The method according to claim 15 further comprising:
encoding order information into a bitstream of the current block, the order information indicating the target filtering order.

18. The method according to claim 14, wherein the determining the target filtering order comprises:
determining a neighboring filtered area of the current block;
inputting, for an i-th filtering order in the plurality of filtering orders, a first chrominance component and a second chrominance component of the neighboring filtered area into the neural network filter according to the i-th filtering order to determine an i-th second filtering cost of the neighboring filtered area in the i-th filtering order, i being a positive integer less than or equal to a number N of the plurality of filtering orders; and
determining the target filtering order from the plurality of filtering orders based on second filtering costs corresponding to the plurality of filtering orders.

19. A decoding apparatus, comprising:
processing circuitry configured to:
reconstruct a current picture that is encoded in a coded bitstream;
determine, for a current block in the reconstructed current picture, a target filtering order from a plurality of filtering orders of a first chrominance component and a second chrominance component of the current block; and
input, based on the determined target filtering order, the first chrominance component and the second chrominance component of the current block into a neural network filter to obtain a chrominance filtering block of the current block.

20. The decoding apparatus according to claim 19, wherein the processing circuitry is configured to:
determine, for the current block in the reconstructed current picture, the target filtering order from the plurality of filtering orders based on one of (i) first information in the coded bitstream that indicates the target filtering order and (ii) filtering costs of the plurality of filtering orders.
